(19) United States
(12) Patent Application Publication
(10) Pub. No.: US 2025/0225865 A1
(43) Pub. Date: Jul. 10, 2025

(54) SYSTEM AND METHOD USES V2X COMMUNICATION TO IDENTIFY AN ERRATIC DRIVER AND COMMUNICATES INFORMATION ABOUT A VEHICLE DRIVEN ERRATICALLY TO OTHER VEHICLES

(71) Applicant: Volvo Car Corporation, Göteborg (SE)

(72) Inventors: Xingyun Yang, Göteborg (SE); Egoi Sanchez Basualdo, Göteborg (SE); Ashok Chaitanya KOPPISETTY, Göteborg (SE); Kostas Chatziioannou, Göteborg (SE)

(21) Appl. No.: 18/409,255

(22) Filed: Jan. 10, 2024

(51) Int. Cl. G08G 1/01; G08G 1/017; G08G 1/0967; G08G 1/16

(52) U.S. Cl. CPC G08G 1/0141; G08G 1/0108; G08G 1/017; G08G 1/0967; G08G 1/166

(57) ABSTRACT

According to an embodiment, it is a system comprising, a communication module, and a processor; wherein the processor storing instructions in a non-transitory memory that, when executed, cause the processor to receive, a first message by a host vehicle via the communication module from a source, wherein the first message comprises information on an erratic vehicle, wherein the information comprises one or more of a license plate number, a make and model, a color, a first contact zone, a location of the erratic vehicle, and a direction of travel of the erratic vehicle; and transmit a second message, via the communication module, to alert a second vehicle, wherein the second message comprises a part of the first message, a second contact zone, and an evasive action for the second vehicle.

### FIELD OF THE INVENTION

The present disclosure relates to situational awareness for on-road vehicles, more particularly to a system and a method for detecting erratic vehicles, anticipating a collision from an erratic vehicle, and evasive actions for erratic vehicles.

### BACKGROUND

The problem is that when a driver exhibiting erratic behavior is present on the road and the erratic vehicle may potentially come in contact with a host vehicle, the driver of the host vehicle lacks the means to determine how to avoid or prevent a collision.

Therefore, there is a need for a system and method which can provide information to the nearby vehicles about the erratic vehicle and recommend an action to avoid a collision.

### SUMMARY

The following presents a summary to provide a basic understanding of one or more embodiments described herein. This summary is not intended to identify key or critical elements or delineate any scope of the different embodiments and/or any scope of the claims. The purpose of the summary is to present some concepts in a simplified form as a prelude to the more detailed description presented herein.

According to an embodiment, it is a system comprising, a communication module, and a processor; wherein the processor storing instructions in a non-transitory memory that, when executed, cause the processor to receive, a first message by a host vehicle via the communication module from a source, wherein the first message comprises information on an erratic vehicle, wherein the information comprises one or more of a license plate number, a make and model, a color, a first contact zone, a location of the erratic vehicle, and a direction of travel of the erratic vehicle; and transmit a second message, via the communication module, to alert a second vehicle, wherein the second message comprises a part of the first message, a second contact zone, and an evasive action for the second vehicle; and wherein the system is a component of the host vehicle, and wherein the source is one of a first vehicle, a device, and a traffic infrastructure.

According to an embodiment, it is a method comprising, receiving, a first message by a host vehicle via a communication module from a source, wherein the first message comprises information on an erratic vehicle, wherein the information comprises one or more of a license plate number, a make and model, a color, a first contact zone, a location of the erratic vehicle, and a direction of travel of the erratic vehicle; and transmitting a second message, via the communication module, to alert a second vehicle, wherein the second message comprises a part of the first message and an evasive action for the second vehicle, and wherein the source is one of a first vehicle, a device, and a traffic infrastructure.

According to an embodiment, it is a non-transitory computer readable storage medium having stored thereon instructions executable by a computer system to perform operations comprising, receiving, a first message by a host vehicle via a communication module from a source, wherein the first message comprises information on an erratic vehicle, wherein the information comprises one or more of a license plate number, a make and model, a color, a first contact zone, a location of the erratic vehicle, and a direction of travel of the erratic vehicle; and transmitting a second message, via the communication module, to alert a second vehicle, wherein the second message comprises a part of the first message and an evasive action for the second vehicle, and wherein the source is one of a first vehicle, a device, and a traffic infrastructure.

According to an embodiment, it is a system comprising, a communication module, and a processor; wherein the processor storing instructions in a non-transitory memory that, when executed, cause the processor to: transmit a message, by a host vehicle via the communication module about an erratic vehicle, to alert a nearby vehicle, wherein the message comprises one or more of a license plate number, a make and model, a color, a location of the erratic vehicle, and a direction of travel of the erratic vehicle.

According to an embodiment, it is a method comprising, transmitting a message, by a host vehicle via a communication module about an erratic vehicle, to alert a nearby vehicle, wherein the message comprises one or more of a license plate number, a make and model, a color, a location of the erratic vehicle, and a direction of travel of the erratic vehicle.

According to an embodiment, it is a non-transitory computer readable storage medium having stored thereon instructions executable by a computer system to perform operations comprising, transmitting a message, by a host vehicle via a communication module about an erratic vehicle, to alert a nearby vehicle, wherein the message comprises one or more of a license plate number, a make and model, a color, a location of the erratic vehicle, and a direction of travel of the erratic vehicle.

### BRIEF DESCRIPTION OF THE FIGURES

These and other aspects of the present invention will now be described in more detail, with reference to the appended drawings showing exemplary embodiments of the present invention, in which:

FIG. 1 is an illustration of an example autonomous vehicle with various sensors, actuators, and systems according to an embodiment.

FIG. 2 shows a block diagram of electronic components of a vehicle according to an embodiment.

FIG. 3 shows the block diagram of the system and its components for detecting an erratic vehicle, predicting a collision probability, and recommending an evasive action according to an embodiment.

FIG. 4 shows the erratic vehicle detection module and various indicators for detecting erratic behavior according to an embodiment.

FIG. 5A shows a broadcast of a message to all the nearby vehicles upon detection of an erratic vehicle according to an embodiment.

FIG. 5B shows a broadcast of a message to a group of nearby vehicles upon detection of an erratic vehicle according to an embodiment.

FIG. 5C shows transmission of a customized message to the nearby vehicles upon detection of an erratic vehicle according to an embodiment.

FIG. 5D shows transmission of a message to law enforcing agency and emergency services upon detection of an erratic vehicle according to an embodiment.

FIG. 6 shows the contact zones around the erratic vehicle according to an embodiment.

FIG. 7A shows a transmitted message or a communication message that is transmitted to a nearby vehicle, displayed on an infotainment system of the nearby vehicle, which includes a graphic that is generated according to an embodiment.

FIG. 7B shows an example broadcast message when an erratic vehicle is detected according to an embodiment.

FIG. 7C shows an example of a message and content of the message that may be transmitted from a host vehicle to a nearby vehicle.

FIG. 8A shows a structure of the neural network/machine learning model with a feedback loop according to an embodiment.

FIG. 8B shows a structure of the neural network/machine learning model with reinforcement learning according to an embodiment.

FIG. 8C shows an example block diagram for identifying an erratic behavior and erratic vehicle using a machine learning model according to an embodiment.

FIG. 8D shows an example flow chart for continuous monitoring for erratic vehicles and recommending an action using a machine learning model according to an embodiment.

FIG. 8E shows an example flow chart for coordinated moving of vehicles using swarm intelligence to avoid a collision/contact zone with the erratic vehicle.

FIG. 9A shows a block diagram for a method for detecting an erratic vehicle and determining an evasive action according to an embodiment.

FIG. 9B shows a block diagram for a system for detecting an erratic vehicle and determining an evasive action according to an embodiment.

FIG. 9C shows a block diagram for a method stored on a non-transitory computer medium for detecting an erratic vehicle and determining an evasive action according to an embodiment.

FIG. 10A shows a block diagram for a method for receiving and transmitting a message by the host vehicle according to an embodiment.

FIG. 10B shows a block diagram for a system for receiving and transmitting a message by the host vehicle according to an embodiment.

FIG. 10C shows a block diagram for a method stored on a non-transitory computer medium for receiving and transmitting a message by the host vehicle according to an embodiment.

FIG. 11A shows a block diagram for a method for transmitting a message by the host vehicle according to an embodiment.

FIG. 11B shows a block diagram for a system for transmitting a message by the host vehicle according to an embodiment.

FIG. 11C shows a block diagram for a method stored on a non-transitory computer medium for transmitting a message by the host vehicle according to an embodiment.

FIG. 12A shows the block diagram of the cyber security module according to an embodiment.

FIG. 12B shows the flowchart of securing the data through the cyber security module.

FIG. 12C shows the flowchart of securing the data through the cyber security module.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more.” Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer readable storage medium for execution by, or to control the operation of, data processing apparatus. The computer readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general purpose computer including computer hardware. Embodiments within the scope of the present invention may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments of the invention can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Module (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multiprocessor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall be understood to have the following meanings.

As used herein, the term “Cryptographic protocol” is also known as security protocol or encryption protocol. It is an abstract or concrete protocol that performs a security-related function and applies cryptographic methods often as sequences of cryptographic primitives. A protocol describes usage of algorithms. A sufficiently detailed protocol includes details about data structures and representations, to implement multiple, interoperable versions of a program.

Secure application-level data transport widely uses cryptographic protocols. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation.

Networking switches use cryptographic protocols, like Secure Socket Layer (SSL) and Transport Layer Security (TLS), the successor to SSL, to secure data communications over a wireless network.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naïve Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “Sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses etc. are examples of vehicles.

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems, designed for the purpose, interpret sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

Further, the communication apparatus is configured on a computer with the communication function and is connected for bidirectional communication with the on-vehicle emergency report apparatus by a communication line through a radio station and a communication network such as a public telephone network or by satellite communication through a communication satellite. The communication apparatus is adapted to communicate, through the communication network, with communication terminals.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHZ (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware.

The term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module” (ECM), is usually a module that controls one or more subsystems. Herein, an ECU may be installed in a car or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer readable storage medium” and “computer readable storage medium” include a single medium or multiple media such as a centralized or distributed database, and/or associated caches and servers that store one or more sets of instructions. Further, the terms “non-transitory computer readable storage medium” and “computer readable storage medium” include any tangible medium that is capable of storing, encoding, or carrying a set of instructions for execution by a processor that, for example, when executed, cause a system to perform any one or more of the methods or operations disclosed herein. As used herein, the term “computer readable storage medium” is expressly defined to include any type of computer readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers-say, ‘A’ is ‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DOS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages. Programming languages may be high-level programming languages, low-level programming languages, compiled languages, interpreted languages, scripting languages, functional programming languages, markup languages etc. It includes object oriented programming languages such as Smalltalk, C++, or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode.

The term “host vehicle” as used herein refers to a vehicle that is observing the environment in order to decide based on observations.

The term “target vehicle” as used herein refers to a vehicle on which the host vehicle has a focus. The target vehicle may or may not be an autonomous vehicle. It may or may not have been enabled for Vehicle-to-Vehicle (V2V) communication.

The term “nearby vehicle” or “neighboring vehicle” or “surrounding vehicle” as used herein refers to a vehicle anywhere near to the host vehicle within a communication range of the host vehicle. It may or may not be an autonomous vehicle. It may or may not have been enabled for V2V communication. In some embodiments, a neighboring vehicle may more specifically refer to a vehicle that is immediately in the next lane or behind the host vehicle.

The term “road surface condition” as used herein refers to the physical state of the roadway, including its smoothness, texture, and friction. It can be affected by several factors such as weather, traffic volume, pits, and maintenance practices.

The term “erratic vehicle” as used herein refers to vehicles, such as a car, truck, motorcycle, or any other mode of transportation, that demonstrates unpredictable, irregular, or unsteady behavior on the road. It may further include scenarios such as vehicles in an accident zone, an emergency response vehicle, etc. In general, it may include any vehicle that disrupts the normal flow of the traffic.

The term “erratic driving behavior” as used herein refers to abrupt and sudden changes in speed, erratic lane changes without signaling, inconsistent steering patterns, aggressive maneuvers, or actions that deviate significantly from standard safe driving practices.

The term “adaptive” as used herein refers to the ability to adjust or modify the systems in response to varying conditions, circumstances, or input. When adaptive, the system is capable of adjusting and updating the scan frequency based on the changing conditions during a drive. For example, adaptive scan frequency can adjust or modify the system to scan the surroundings according to a current situation, environment, and requirements. As the conditions change, the system continuously recalibrates the scan frequency.

The term “vehicle pursuit” as used herein refers to an event involving one or more law enforcement officers attempting to apprehend a suspect who is attempting to avoid arrest while operating a motor vehicle by using high speed driving or other evasive tactics such as driving off a highway, turning suddenly or driving in a legal manner but willfully failing to yield to an officer's signal to stop. It is a situation where the law enforcement officers drive very fast to try to catch someone in a vehicle. It is also referred to as high-speed chase.

The term “traffic infrastructure” refers to the physical and organizational components of a transportation system that facilitate vehicle movement, safety, and efficiency. In the context of communication with vehicles, it involves the integration of advanced technologies within the transportation network. This includes systems such as intelligent traffic management, adaptive signal control, variable message signs, and connected vehicle technology. It includes elements and devices that work together to provide real-time information on traffic conditions, optimize signal timings, and enable communication between vehicles and infrastructure.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

The problem is that when there is an erratic driver of a vehicle on the road, which can come into contact with the current driver, there is no way for the current driver to know how to avoid a collision. Thus, a system is needed that can provide information to vehicles or the current drivers that an erratic driver is approaching, in which to allow the vehicles or current drivers to take action to avoid a collision or to recommend the vehicles or current drivers to take a different route.

In an aspect, the system scans at frequency level one to determine if there are drivers behaving erratically. This can be done by monitoring current traffic reports. In an aspect, each vehicle is equipped with sensor (e.g., cameras, lidars, infrared, etc.) and V2X communication modules to monitor driving behaviors of other drivers that can determine if a driver is not following local driving rules. Drivers behaving erratically could be, for example, a driver in a high-speed chase, a drunk driver, an incompetent driver due to health failure, a driver of a police/ambulance/fire vehicle, or any other vehicles attending to an urgent call. When a vehicle determines that such a vehicle is on the road or near its location, the system will initiate evasive procedure to avoid contact with the vehicle driven erratically. In addition, the vehicle, detecting the vehicle driven erratically, will broadcast a message to alert nearby vehicles and to request a daisy chain communication to notify all the vehicles within a geographical range or route. In an aspect, if the host vehicle is surrounded or blocked by vehicles, the system will broadcast a request to the surrounding or blocking vehicles to create a gap to be used to avoid a collision. In an aspect, a vehicle comprises a method to receive or transmit a message comprising an alert and request to create space for the transmitting/host vehicle. The message may include a specific direction to move the vehicle, e.g., stop, reverse, right or left movement.

In an embodiment, the vehicle messages nearby vehicles using V2X messaging. The message comprises the geographical location of the vehicle driven erratically, vehicle information and potential evasive action the driver can take to avoid any collision or contact with/by the vehicle driven erratically.

The system needs to receive information from cameras, sensors and other vehicles that would be closer to the vehicle being driven erratically. The message comprises VIN, color of the vehicle, direction the erratic vehicle is traveling, location, speed of the vehicle, and whether or not the vehicle driven erratically has V2X communication capabilities.

The system needs to determine corrective action/evasive action. For example, if the system determines that collision is likely to occur without it taking action, the system will identify a corrective course and display the actions to the operator of the vehicle.

Having such an Artificial Intelligence (AI) system in the vehicle is very useful to avoid accidents. Such a system is very useful when there is a high speed chase, and the erratically driven vehicle is headed towards the host vehicle. The operator, having this knowledge, can alert other vehicles about the route to avoid.

When the operator provides the destination, the system begins scanning for high speed chase or any reported erratically driven vehicle (cars, bikes, etc.). If the system determines that there is a possibility of collision, the system provides an alert and provides a suggested route with consideration of energy and other factors.

Vehicles exhibiting erratic behavior pose a potential risk to road safety, as their unpredictable movements can lead to accidents, collisions, and disruptions in traffic flow. Erratic driving can result from various factors, including driver impairment, distraction, fatigue, or intentional reckless behavior. Identifying and addressing erratic vehicles is crucial for maintaining overall road safety and preventing potential accidents.

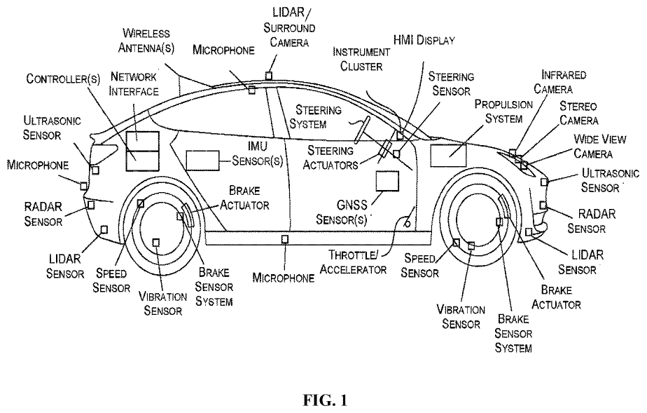

FIG. 1 is an illustration of a vehicle with various sensors, actuators, and systems according to an embodiment. The vehicle comprises various sensors, such as ultrasonic sensor, Light Detection and Ranging (LIDAR) sensors, Radio Detection and Ranging (RADAR) sensors, etc., actuators such as brake actuator, steering actuators, etc., and various subsystems such as propulsion system, steering system, brake sensor system, communication system, etc. FIG. 1 is depicted as an example system; neither is it limited by the systems depicted nor is it an exhaustive list of the sensors, actuators, and systems/subsystems, and/or features of the vehicle. In an embodiment, the vehicle is an autonomous vehicle. Further, the vehicle shown should not be construed as limiting in terms of the arrangement of any of the sensors, actuators, and systems/subsystems depicted. These sensors, actuators, and systems/subsystems can be arranged as suited for a purpose to be performed by the autonomous vehicle. Autonomous vehicles, also known as self-driving vehicles or driverless vehicles, are vehicles that can navigate and operate without human intervention. Sensors, for example, including cameras, LIDARs, radars, and ultrasonic sensors, enable autonomous vehicles to detect and recognize objects, obstacles, and pedestrians on the road. Autonomous vehicles use advanced control systems to make real-time decisions based on sensor data and pre-programmed rules or intelligence-based decision systems. These systems control, for example, acceleration, braking, steering, and communication of the vehicle. Navigation systems such as Global Positioning System (GPS), maps, and other location-based technologies help autonomous vehicles navigate and plan the optimal route to a destination. Communication systems of autonomous vehicles help them communicate with other vehicles and infrastructure, such as traffic lights and road signs, to exchange information and optimize traffic flow. Autonomous vehicles have several safety features, including collision avoidance systems, emergency braking, and backup systems in case of system failures. Autonomous vehicles are assisted by artificial intelligence and machine learning algorithms to analyze data, recognize patterns, and improve performance over time.

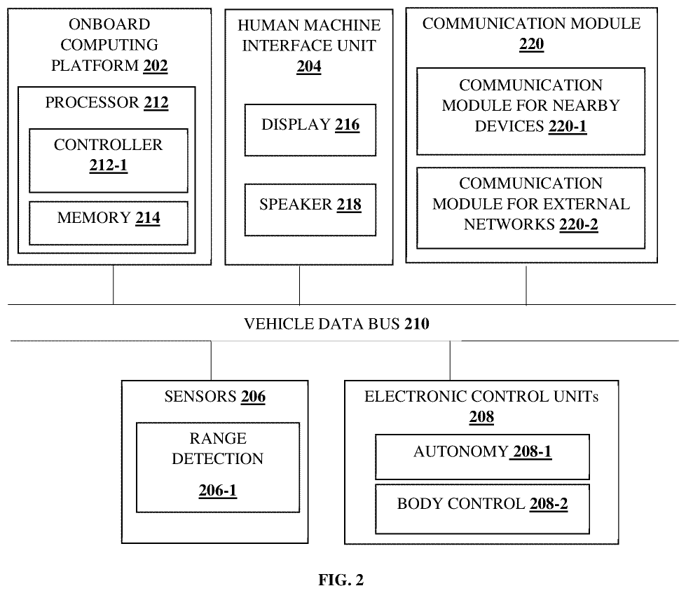

FIG. 2 shows a block diagram of electronic components of a vehicle according to an embodiment. In the illustrated example, the electronic components include an onboard computing platform 202, a human-machine interface (HMI) unit 204, the communication module 220, sensors 206, electronic control units (ECUs) 208, and a vehicle data bus 210. FIG. 2 illustrates an example architecture of some of the electronic components as displayed in FIG. 1.

The onboard computing platform 202 includes a processor 212 (also referred to as a microcontroller unit or a controller) and memory 214. In the illustrated example, processor 212 of the onboard computing platform 202 is structured to include the controller 212-1. In other examples, the controller 212-1 is incorporated into another ECU with its own processor and memory. The processor 212 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 214 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 214 includes multiple kinds of memory, particularly volatile memory, and non-volatile memory. Memory 214 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 214, the computer readable storage medium, and/or within the processor 212 during execution of the instructions.

The HMI unit 204 provides an interface between the vehicle and a user. The HMI unit 204 includes digital and/or analog interfaces (e.g., input devices and output devices) to receive input from, and display information for, the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), haptic devices, actuators, a display 216 (e.g., a heads-up display, a center console display such as a liquid crystal display (LCD), an organic light emitting diode (OLED) display, a flat panel display, a solid state display, etc.), and/or a speaker 218. For example, the display 216, the speaker 218, and/or other output device(s) of the HMI unit 204 are configured to emit an alert, such as an alert to request manual takeover to an operator (e.g., a driver) of the vehicle. Further, the HMI unit 204 of the illustrated example includes hardware (e.g., a processor or controller, memory, storage, etc.) and software (e.g., an operating system, etc.) for an infotainment system that is presented via display 216.

Sensors 206 are arranged in and/or around the vehicle to monitor properties of the vehicle and/or an environment in which the vehicle is located. One or more of the sensors 206 may be mounted to measure properties around an exterior of the vehicle. Additionally, or alternatively, one or more of sensors 206 may be mounted inside a cabin of the vehicle or in a body of the vehicle (e.g., an engine compartment, wheel wells, etc.) to measure properties of the vehicle and/or interior sensing of the vehicle. For example, the sensors 206 include accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. In the illustrated example, sensors 206 include the range-detection sensors that are configured to monitor object(s) located within a surrounding area of the vehicle. Sensors may comprise range detection sensors 206-1 such as LIDAR, radar, cameras, ultrasonic sensors, GPS sensors, proximity sensors, etc., to detect distance between the vehicle and an object or target in its vicinity.

The ECUs 208 monitor and control the subsystems of the vehicle. For example, the ECUs 208 are discrete sets of electronics that include their own circuit(s) (e.g., integrated circuits, microprocessors, memory, storage, etc.) and firmware, sensors, actuators, and/or mounting hardware. The ECUs 208 communicate and exchange information via a vehicle data bus (e.g., the vehicle data bus 210). Additionally, the ECUs 208 may communicate properties (e.g., status of the ECUs, sensor readings, control state, error, and diagnostic codes, etc.) and/or receive requests from each other. For example, the vehicle may have dozens of the ECUs that are positioned in various locations around the vehicle and are communicatively coupled by the vehicle data bus 210.

In the illustrated example, the ECUs 208 include the autonomy unit 208-1 and a body control module 208-2. For example, the autonomy unit 208-1 is configured to perform autonomous and/or semi-autonomous driving maneuvers (e.g., defensive driving maneuvers) of the vehicle based upon, at least in part, instructions received from the controller 212-1 and/or data collected by the sensors 206 (e.g., range-detection sensors). Further, the body control module 208-2 controls one or more subsystems throughout the vehicle, such as power windows, power locks, an immobilizer system, power mirrors, etc. For example, the body control module 208-2 includes circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc.

The vehicle data bus 210 communicatively couples the communication module 220, the onboard computing platform 202, the HMI unit 204, the sensors 206, and the ECUs 208. In some examples, the vehicle data bus 210 includes one or more data buses. The vehicle data bus 210 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

The communication module 220-1 is configured to communicate with other nearby communication devices. In the illustrated example, communication module 220 includes a dedicated short-range communication (DSRC) module. A DSRC module includes antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication.

V2V communication allows vehicles to share information such as speed, position, direction, and other relevant data, enabling them to cooperate and coordinate their actions to improve safety, efficiency, and mobility on the road. V2V communication can be used to support a variety of applications, such as collision avoidance, lane change assistance, platooning, and traffic management. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road. V2V communication enables vehicles to share data about their location, speed, direction, acceleration, and braking with other nearby vehicles, which can help improve safety, reduce congestion, and enhance the efficiency of transportation systems.

V2V communication is typically based on wireless communication protocols such as Dedicated Short-Range Communications (DSRC) or Cellular Vehicle-to-Everything (C-V2X) technology. With V2V communication, vehicles can receive information about potential hazards, such as accidents or road closures, and adjust their behavior accordingly. V2V communication can also be used to support advanced driver assistance systems (ADAS) and automated driving technologies, such as platooning, where a group of vehicles travel closely together using V2V communication to coordinate their movements.

More information on the DSRC network and how the network may communicate with vehicle hardware and software is available in the U.S. Department of Transportation's Core June 2011 System Requirements Specification (SyRS) report (available at http://wwwits.dot.gov/meetings/pdf/CoreSystemSESyRSRevA % 20 (2011-06-13).pdf). DSRC systems may be installed on vehicles and along roadsides on infrastructure. DSRC systems incorporating infrastructure information are known as a “roadside” system. DSRC may be combined with other technologies, such as Global Position System (GPS), Visual Light Communications (VLC), Cellular Communications, and short-range radar, facilitating the vehicles communicating their position, speed, heading, relative position to other objects and to exchange information with other vehicles or external computer systems. DSRC systems can be integrated with other systems such as mobile phones.

Currently, the DSRC network is identified under the DSRC abbreviation or name. However, other names are sometimes used, usually related to a Connected Vehicle program or the like. Most of these systems are either pure DSRC or a variation of the IEEE 802.11 wireless standard. However, besides the pure DSRC system it is also meant to cover dedicated wireless communication systems between vehicles and roadside infrastructure systems, which are integrated with GPS and are based on an IEEE 802.11 protocol for wireless local area networks (such as 802.11p, etc.).

Additionally, or alternatively, the communication module 220-2 includes a cellular vehicle-to-everything (C-V2X) module. A C-V2X module includes hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is configured to communicate with nearby devices (e.g., vehicles, roadside units, mobile devices, etc.) directly and/or via cellular networks. Currently, standards related to C-V2X communication are being developed by the 3rd Generation Partnership Project.

Further, the communication module 220-2 is configured to communicate with external networks. For example, the communication module 220-2 includes hardware (e.g., processors, memory, storage, antenna, etc.) and software to control wired or wireless network interfaces. In the illustrated example, the communication module 220-2 includes one or more communication controllers for cellular networks (e.g., Global System for Mobile Communications (GSM), Universal Mobile Telecommunications System (UMTS), Long Term Evolution (LTE), Code Division Multiple Access (CDMA)), Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module 220-2 includes a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet; a private network, such as an intranet; or combinations thereof, and may utilize a variety of networking protocols now available or later developed including, but not limited to, TCP/IP-based networking protocols.

In an embodiment of the system, the communication between the host vehicle and the nearby vehicles is via Vehicle-to-Vehicle (V2V) communication. In an embodiment of the system, the Vehicle-to-Vehicle (V2V) communication is based on wireless communication protocols using at least one of a Dedicated Short-Range Communications (DSRC), and a Cellular Vehicle-to-Everything (C-V2X) technology. In an embodiment of the system, the communication between the host vehicle and the nearby vehicles is via an internet connection.

In an embodiment, the communication module is enabled for autonomous communication, wherein the autonomous communication comprises communication over a period with minimal supervision under different scenarios. The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

The autonomy unit 208-1 of the illustrated example is configured to perform autonomous and/or semi-autonomous driving maneuvers, such as defensive driving maneuvers, for the vehicle. For example, the autonomy unit 208-1 performs the autonomous and/or semi-autonomous driving maneuvers based on data collected by the sensors 206. In some examples, the autonomy unit 208-1 is configured to operate a fully autonomous system, a park-assist system, an advanced driver-assistance system (ADAS), and/or other autonomous system(s) for the vehicle.

An ADAS is configured to assist a driver in safely operating the vehicle. For example, the ADAS is configured to perform adaptive cruise control, collision avoidance, lane-assist (e.g., lane centering), blind-spot detection, rear-collision warning(s), lane departure warnings and/or any other function(s) that assist in operating the vehicle. To perform the driver-assistance features, the ADAS monitors objects (e.g., vehicles, pedestrians, traffic signals, etc.) and develops situational awareness around the vehicle. For example, the ADAS utilizes data collected by the sensors 206, the communication module 220-1 (e.g., from other vehicles, from roadside units, etc.), the communication module 220-2 from a remote server, and/or other sources to monitor the nearby objects and develop situational awareness.

Further, in the illustrated example, controller (or control module) 212-1 is configured to monitor an ambient environment of the vehicle. For example, to enable the autonomy unit 208-1 to perform autonomous and/or semi-autonomous driving maneuvers, the controller 212-1 collects data that is collected by sensors 206 of the vehicle. In some examples, the controller 212-1 collects location-based data via the communication module 220-1 and/or another module (e.g., a GPS receiver) to facilitate the autonomy unit 208-1 in performing autonomous and/or semi-autonomous driving maneuvers. Additionally, the controller 212-1 collects data from (i) adjacent vehicle(s) via the communication module 220-1 and V2V communication and/or (ii) roadside unit(s) via the communication module 220-1 and V2I communication to further facilitate the autonomy unit 208-1 in performing autonomous and/or semi-autonomous driving maneuvers.

In operation, according to an embodiment, the communication module 220-1 performs V2V communication with an adjacent vehicle. For example, the communication module 220-1 collects data from the adjacent vehicle that identifies (i) whether the adjacent vehicle includes an autonomous and/or semi-autonomous system (e.g., ADAS), (ii) whether the autonomous and/or semi-autonomous system is active, (iii) whether a manual takeover request of the autonomous and/or semi-autonomous system has been issued, (iv) lane-detection information of the adjacent vehicle, (v) a speed and/or acceleration of the adjacent vehicle, (vi) a (relative) position of the adjacent vehicle, (vii) a direction-of-travel of the adjacent vehicle, (viii) a steering angle rate-of-change of the adjacent vehicle, (ix) dimensions of the adjacent vehicle, (x) whether the adjacent vehicle is utilizing stability control system(s) (e.g., anti-lock braking, traction control, electronic stability control, etc.), and/or any other information that facilitates the controller 212-1 in monitoring the adjacent vehicle.

Based at least partially on the data that the communication module 220-1 collects from the adjacent vehicle via V2V communication, the controller 212-1 can determine a collision probability for the adjacent vehicle. For example, the controller 212-1 determines a collision probability for the adjacent vehicle in response to identifying a manual takeover request within the data collected by the communication module 220-1 from the adjacent vehicle. Additionally, or alternatively, the controller 212-1 determines a collision probability for the adjacent vehicle in response to identifying a discrepancy between (i) lane-marker locations determined by the controller 212-1 of the vehicle based on the sensors 206 and (ii) lane-marker location determined by the adjacent vehicle. Further, in some examples, the controller 212-1 determines the collision probability for the adjacent vehicle based on data collected from other sources, such as the sensors 206, e.g., range detector sensors 206-1 and/or other sensor(s) of the vehicle, roadside unit(s) in communication with the communication module 220-1 via V2I communication, and/or remote server(s) in communication with the communication module 220-2.

In some examples, controller 212-1 determines the collision probability based on a takeover time for the adjacent vehicle and/or a time-to-collision of the adjacent vehicle. For example, the takeover time corresponds with a duration of time between (1) the adjacent vehicle emitting a request for a manual takeover to be performed and (2) an operator of the adjacent vehicle manually taking over control of the adjacent vehicle. The controller 212-1 is configured to determine the takeover time of the adjacent vehicle based on measured characteristics of the adjacent vehicle (e.g., velocity, acceleration, dimensions, etc.), the operator of the adjacent vehicle (e.g., a measured reaction time, etc.), and/or an environment of the adjacent vehicle (e.g., road conditions, weather conditions, etc.). Further, the time-to-collision corresponds with the time it would take for the adjacent vehicle to collide with another vehicle (e.g., a third vehicle) and/or object (e.g., a guardrail, a highway lane divider, etc.) if the current conditions were maintained.

Additionally, or alternatively, the controller 212-1 is configured to determine the time-to-collision of the adjacent vehicle based on a velocity, an acceleration, a direction-of-travel, a distance to the object, a required steering angle to avoid the object, a steering angle rate-of-change, and/or other measured characteristics of the adjacent vehicle that the communication module 220-1 collects from the adjacent vehicle via V2V communication. Further, controller 212-1 is configured to determine a collision probability for the vehicle based on the collision probability of the adjacent vehicle.

Upon determining the collision probability of the adjacent vehicle and determining that the collision probability is not as per threshold, the autonomy unit 208-1 autonomously performs (e.g., for the ADAS) a defensive driving maneuver to prevent the vehicle from being involved in a collision caused by the adjacent vehicle. For example, the autonomous defensive driving maneuver includes deceleration, emergency braking, changing of lanes, changing of position within a current lane of travel, etc. In some examples, the autonomy unit 208-1 is configured to initiate the defensive driving maneuver before the takeover time of the adjacent vehicle has been completed. That is, the controller 212-1 is configured to cause the autonomy unit 208-1 to perform the defensive driving maneuver before the operator of the adjacent vehicle manually takes over control of the adjacent vehicle. Further, in some examples, the controller 212-1 emits an audio, visual, haptic, and/or other alert (e.g., via an HMI unit 204) for the operator of the vehicle to request manual takeover in response to determining that the collision probability is less than the first threshold and greater than the second threshold. By emitting such an alert, controller 212-1 enables the operator of the vehicle to safely take control of the vehicle before the adjacent vehicle is potentially involved in a collision. Additionally, or alternatively, the controller 212-1 is configured to perform other defensive measures (e.g., prefilling brake fluid lines) in response to determining that the collision probability is greater than a threshold (e.g., the second threshold, a third threshold).

The communication module enables in-vehicle communication, communication with other vehicles, infrastructure communication, grid communication, etc., using Vehicle to network (V2N), Vehicle to infrastructure (V2I), Vehicle to vehicle (V2V), Vehicle to cloud (V2C), Vehicle to pedestrian (V2P), Vehicle to device (V2D), Vehicle to grid (V2G) communication systems. Then, the system notifies nearby or surrounding vehicles or vehicles communicating with the vehicle's communication module. The vehicle uses, for example, a message protocol, a message that goes to the other vehicles via a broadcast.

In an embodiment, a connection is established between the host vehicle and the nearby vehicle/user device. A nearby vehicle is detected by the host vehicle's control system. The nearby vehicle/user device is detected by exchanging handshaking signals. Handshaking is the automated process for negotiation of setting up a communication channel between entities. The processor sends a start signal through the communication channel in order to detect a nearby vehicle/user device. If there is a nearby vehicle/user device, the processor may receive an acknowledgement signal from the nearby vehicle/user device. Upon receiving the acknowledgement signal, the processor establishes a secured connection with the nearby vehicle/user device. The processor may receive a signal at the communication module from the nearby vehicle/user device. The processor may further automatically determine the origin of the signal. The processor communicatively connects the communication module to the nearby vehicle/user device. Then the processor is configured to send and/or receive a message to and/or from the nearby vehicle/user device. The signals received by the communication module may be analyzed to identify the origin of the signal to determine the location of the nearby vehicle/user device.

In an embodiment, the system is enabled for bidirectional communication. The system or vehicle sends a signal and then receives a signal/communication from the nearby vehicle/user device. As a first step of the method according to the disclosure, a data link between the vehicle and the external device is set up in order to permit data to be exchanged between the vehicle and the external device in the form of a bidirectional communication. This can take place, for example, via a radio link or a data cable. It is therefore possible for the external device to receive data from the vehicle or for the vehicle to request data from the external device.

In an embodiment, bidirectional communication comprises the means for data acquisitions and is designed to exchange data bidirectionally with one another. In addition, at least the vehicle comprises the logical means for gathering the data and arranging it to a certain protocol based on the receiving entity's protocol. Initially during handshaking, a data link for bidirectional communication is set up. The vehicle and the external device can communicate with one another via this data link and therefore request or exchange data, wherein the data link can be implemented, for example, as a cable link or radio link.

Bidirectional communication has various advantages as described herein. In various embodiments, data is communicated and transferred at a suitable interval, including, for example, 200 millisecond (ms) intervals, 100 ms intervals, 50 ms intervals, 20 ms intervals, 10 ms intervals, or even more frequent and/or in real-time or near real-time, in order to allow a vehicle to respond to, or otherwise react to, data. Bidirectional communication may be used to facilitate data exchange.

The apparatus for the vehicle according to the embodiment that performs bidirectional communication may be by means of a personal area network (PAN) modem. Therefore, a user can have access to an external device using the vehicle information terminal, and can then store, move, and delete the user's desired data.

In an embodiment, the vehicle may transmit a message via a communication link. It can be using any combination of vehicle to vehicle (V2V), vehicle to everything (V2X) or vehicle to infrastructure (V21) type of communication. In an embodiment, it uses vehicle-to-vehicle (V2V) communication that enables vehicles to wirelessly exchange information (communicate), for example, about their speed, location, and heading.

In an embodiment, messaging protocols comprise of at least one of Advanced Message Queuing Protocol (AMQP), Message Queuing Telemetry Transport (MQTT), Simple (or Streaming) Text Oriented Message Protocol (STOMP), MQTT-S(an extension of the open publish/subscribe MQTT), which are heavily used in IoT based technologies and edge networks.

In an embodiment of the system, the host vehicle is operable to establish a communication via a communication module with the external device to obtain information on the current state, wherein the state comprises traffic conditions, road conditions, weather conditions, etc. In an embodiment of the system, information is obtained via sensors of the vehicle using an accelerometer sensor, a GPS, an Inertial Measurement Unit (IMU), a LIDAR, a radar, and a camera.

In an embodiment of the system, the communication between the host vehicle and the nearby vehicle is via Vehicle-to-Vehicle (V2V) communication. In an embodiment of the system, V2V communication is based on wireless communication protocols using at least one of a Dedicated Short-Range Communications (DSRC), and a Cellular Vehicle-to-Everything (C-V2X) technology. In an embodiment of the system, the communication between the host vehicle and the nearby vehicle is via an internet connection.

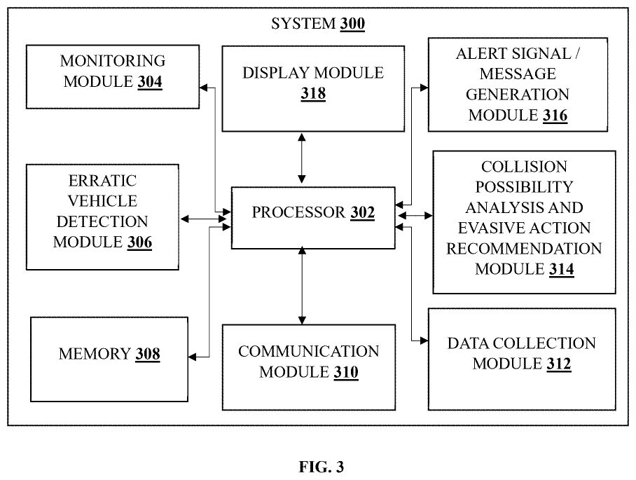

FIG. 3 shows the block diagram of the system and its components for detecting an erratic vehicle, predicting a collision probability, and recommending an evasive action according to an embodiment. The system 300 comprises a processor 302, monitoring module 304, erratic vehicle detection module 306, memory 308, communication module 310, data collection module 312, collision possibility analysis and evasive action recommendation module 314, alert signal/message generation module 316, and display module 318.

Processor 302 may be a high-performance, multi-core CPU or system-on-chip (SoC) solution to process vast amounts of data from various sensors that may be used or present in the vehicles. It processes vast amounts of data from sensors, such as cameras, LIDAR, radar, and other inputs, to make real-time decisions, recommendations, and execute control actions for the vehicle. Graphics Processing Units (GPUs) are also utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within or interacting with the processor manages and coordinates the execution of instructions, fetching them from memory, decoding them, and directing the appropriate components to execute the instructions. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, detect obstacles, interpret the environment, and help in decision making to navigate the vehicle. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. The processor interacts and exchanges data with one or more of the other components or modules of the system, for example, monitoring module 304, erratic vehicle detection module 306, memory 308, communication module 310, data collection module 312, collision possibility analysis and evasive action recommendation module 314, alert signal/message generation module 316, and display module 318, as shown in FIG. 3.

Monitoring module 304 comprises various sensors which are configured for monitoring the surroundings for erratic vehicles, any deviations from the normal flow of the traffic, and any other hazardous situations. A monitoring module designed to detect erratic vehicles or deviations in normal traffic by the host vehicle comprises several components and employs Artificial Intelligence/Machine Learning (AI/ML) based algorithms for accurate analysis. The components include sensors and interact with processor 302, communication module 310, to decide or determine the erratic vehicle. Sensors, such as cameras, lidar, radar, and inertial measurement units, are strategically placed on the host vehicle to capture real-time data about its surroundings. These sensors generate a continuous stream of information, which is then processed by the processors. Advanced algorithms, often involving computer vision, machine learning, and sensor fusion techniques, are applied to analyze the data and identify patterns indicative of erratic behavior or deviations from standard traffic norms. The monitoring process involves constantly collecting and updating information from the sensors, extracting relevant features, and feeding this data into the algorithms. These algorithms are trained to recognize various scenarios, including sudden acceleration, abrupt lane changes, or inconsistent speed patterns. The decision-making unit interprets the results and determines the appropriate response based on the severity of the detected deviation. Communication interfaces enable the monitoring module to alert the vehicle's driver through visual or auditory cues and can also communicate with other vehicles or a central traffic management system, facilitating a coordinated response to ensure overall road safety. This comprehensive approach to monitoring and detection enhances the host vehicle's ability to proactively respond to potential hazards and contribute to the overall safety and efficiency of the traffic ecosystem.

In an embodiment of the system, the configuration of the vehicle is determined via the computer vision module comprising an artificial intelligence engine, wherein the artificial intelligence engine comprises a machine learning algorithm. In an embodiment of the system, when a deviation from normal traffic or an erratic vehicle is observed, the system may activate a camera of the computer vision module to record surroundings of the vehicle. In an embodiment, the size and shape of the erratic vehicle may be detected using various sensors that are situated strategically in and on the vehicle.

Adaptive scanning algorithm/Dynamic scanning algorithm: Efficiently monitoring surroundings for erratic vehicles or other deviations in the traffic from normal patterns while conserving the power of an adaptive scanning algorithm can be implemented. The algorithm involves adjusting the scanning frequency based on the current traffic conditions and the likelihood of encountering erratic behavior. The system would start with an initial low to moderate scanning frequency to capture general traffic information. The system sets low-power mode to conserve energy during periods of low expected activity. In an embodiment, the system is operable with dynamic frequency adjustment. The system would continuously analyze the processed data to assess the current level of traffic normalcy. If the system detects deviations or identifies potential erratic behavior, it will dynamically increase the scanning frequency to obtain more detailed information in real-time. Conversely, the system would reduce the scanning frequency during periods of stable and predictable traffic to conserve power.

The system would utilize machine learning algorithms for traffic pattern analysis to identify typical traffic patterns during different times of the day, days of the week, or specific road conditions. It will adjust the scanning frequency based on historical patterns to optimize power consumption without compromising safety.

The system implements a hierarchical sensor activation where different sensors are activated in a hierarchical approach based on the urgency of the situation. It may use low-power sensors for initial scans and activate higher-power sensors selectively when potential erratic behavior is detected. The system would implement an adaptive power management strategy that balances the need for real-time monitoring with energy conservation. It allows the system to enter low-power mode during periods of inactivity or when the likelihood of detecting erratic behavior is low. In an embodiment, the system will incorporate feedback from the host vehicle's driver to adjust scanning parameters. For instance, if the driver activates a turn signal or changes lanes, the system may temporarily increase the scanning frequency to ensure safety during maneuvers. Adaptive scanning approach allows the monitoring module to be responsive to changing conditions and ensures a balance between safety and energy efficiency.

Machine learning models utilize historical traffic data to identify patterns in normal driving behavior. The model analyzes the data for specific times of the day, days of the week, or seasonal variations to establish baseline expectations. Machine Learning Models are trained to recognize normal driving patterns and predict the likelihood of erratic behavior. The models incorporate features such as time of day, traffic density, weather conditions, and road type to enhance the model's accuracy. The ML model takes real-time traffic conditions as input and continuously monitors real-time traffic conditions and adapts scanning frequency based on the current level of congestion and traffic flow. Higher traffic density or congested conditions may increase the likelihood of erratic behavior. ML models use sensor fusion and integrate data from multiple sensors (e.g., cameras, lidar, radar) to create a comprehensive understanding of the environment and evaluate the consistency of information from different sensors to identify situations where erratic behavior is more than likely. Rapid lane changes, sudden acceleration, or frequent use of brakes may suggest erratic behavior in the vicinity. The ML model may consider the adherence to traffic rules and the influence of road infrastructure. For example, in areas with well-defined traffic regulations and infrastructure, the likelihood of erratic behavior may be lower compared to less regulated or complex road environments. The ML model may factor in environmental conditions such as weather (e.g., heavy rain, snow) and visibility where erratic behavior may be more than likely in such adverse weather conditions, and accordingly, the scanning frequency can be adjusted. Further, ML models may implement systems that allow vehicles to share information about detected anomalies or erratic behavior. Collaborative data sharing among vehicles can enhance the overall understanding of the road environment and improve the accuracy of detecting anomalies. When such information is received about erratic behavior, the scanning frequency is dynamically adjusted when approaching, or in the vicinity of, the location. ML model is trained with data and then used with real time data to predict erratic behavior. The data may further include historical data on road types, traffic conditions, roads, and junctions where such behavior is observed in general, for example, historical data on erratic behavior, types of accidents caused by the erratic behavior, etc. When approaching such roads where erratic behavior is more frequent than other places, the model adaptively adjusts the scanning frequency automatically.

For example, if a vehicle is stuck in traffic and identifies an erratic behavior of a driver of a vehicle or an erratic vehicle, the system starts scanning the surroundings. In an embodiment, the system determines how often to scan. The trigger for the scan frequency depends on an identified erratic behavior on a specific road, or information from any infrastructure or surrounding vehicle that there is an erratic driver located in a specific area. Once the host vehicle receives such a message, the system determines how often to monitor based on where the host vehicle is and where it is going; if the driver happens to be two miles away versus close to the erratic driving zone, the scanning frequency may remain consistent or increase, respectively. In an embodiment, the system makes sure that the host vehicle is not going to head in the direction. If the host vehicle happens to continue the frequency of monitoring, changes in the frequency of monitoring may occur based on the erratic driver's location. Erratic driving location or zone could be a trigger because you do not want to waste power, especially in electric vehicles.

Once the presence of an erratic entity within a geographical vicinity of the host vehicle is established, an artificial intelligence module would then determine the frequency of scanning for details on erratic vehicles such as the location and trajectory of the erratic vehicle. In an embodiment, the host vehicle gathers information from other vehicles in the vicinity by receiving data regarding the direction in which the erratic driver is headed. This information allows the host vehicle to make informed decisions, on opting for an alternate route or receiving guidance from other vehicles for a possible continuation on the same route.

In an embodiment, the host vehicle detects and identifies the erratic behavior and transmits the information to other vehicles. In an embodiment, the system adjusts the scan frequency based on the surroundings. In an embodiment, the system provides a mitigation strategy/evasive strategy for avoiding a collision or contact with the host vehicle. The system predicts the probability of the impact of a vehicle with the erratic vehicle and provides an impact score or risk score based on what kind of vehicle is erratic and the nearby cars. For example, an SUV being erratic with other small vehicles around may create a big impact on the smaller vehicles in case of a collision.

When on road there is the possibility of encountering a significant vehicle chase with erratic drivers, and it is often challenging to be aware of such situations until one finds themselves right in the midst of it. The unpredictability of vehicle chases and erratic driving poses a risk, leaving uncertainty about the appropriate course of action. In these scenarios, the potential for getting involved in an accident with an erratic driver is a real concern. Erratic driving may stem from intentional actions or could be a result of health issues affecting the driver.

The system optimizes the scanning process by determining the frequency of scans. Since scanning consumes energy, it is important to strike a balance and avoid unnecessary scans. The system should exhibit intelligence in assessing the need for scanning based on the prevailing conditions. For instance, in the absence of other drivers on the road, there may be no need for scanning. The system should be capable of discerning the traffic situation and dynamically adjusting the scanning frequency. The system monitors the current geographical area and the upcoming two or three miles, considering the intended route. In scenarios where erratic driving is more than likely, such as in densely populated downtown areas or during specific times like late evenings, the system should automatically increase the frequency of monitoring.

If the host vehicle is the only vehicle on the road, such as on a freeway, the scanning frequency would be reduced. However, this reduction can be contingent on traffic conditions. In instances of heavy traffic, it becomes imperative to temporarily increase the frequency to identify any drivers exhibiting erratic behavior, like weaving in and out of lanes. This approach ensures adaptability to various scenarios, such as two lanes, 4 lanes, one way lanes where drivers tend to maneuver unpredictably.

In an embodiment, the system determines the frequency of monitoring and subsequent actions are taken, upon identification of erratic behavior. In an embodiment, the system determines the optimal frequency for monitoring. Once a frequency is established, the process involves utilizing various sources of information. This includes monitoring traffic reports and utilizing sensors to detect V2X (Vehicle-to-Everything) signals.

The system continuously monitors the surroundings at a designated frequency, relying on data from sources like traffic reports and other internal parameters. Upon identifying a situation that warrants attention, it dynamically changes to a higher frequency of monitoring and issues a warning about the presence of an erratic driver, encouraging the user to take evasive action and suggesting an alternative route.

Erratic vehicle detection module 306: The system is operable for identifying the erratic behavior and the erratic vehicle. The system may utilize data from various sources such as host vehicle sensors, traffic cameras, mobile Apps such as Google® Maps, etc. AI/ML modules are trained to identify erratic driving behavior from a range of patterns that deviate from the normative and safe conduct on the road. Signs of erratic driving often include sudden and unexplained accelerations or decelerations, sharp and unpredictable lane changes without signaling, and a notable variability in speed. Tailgating, or closely following other vehicles, poses a significant risk, as does the failure to use turn signals when making maneuvers. Ignoring traffic signs and signals, coupled with aggressive driving actions such as road rage and tailgating, also characterize erratic behavior. Inconsistent steering, drifting between lanes, and frequent and unnecessary braking are additional indicators. Erratic maneuvers at intersections, driving on the shoulder or median, and signs of drowsy driving, like swerving or inconsistent speeds, further contribute to the spectrum of erratic driving patterns. Recognizing these behaviors collectively is essential for identifying erratic driving. In an embodiment, Artificial Intelligence and Machine Learning (AI/ML) modules are utilized to analyze the behavior of drivers on the road and predict erratic vehicles.

According to an embodiment, the system determines at what point to scan and to adjust the frequency of scanning the surroundings, and at what point to slow it down. In an embodiment, the scan frequency is adjusted based on the geographic area or the zone of contact. For example, once the host vehicle reaches within a two-mile range of an identified erratic vehicle, the scanning frequency increases.

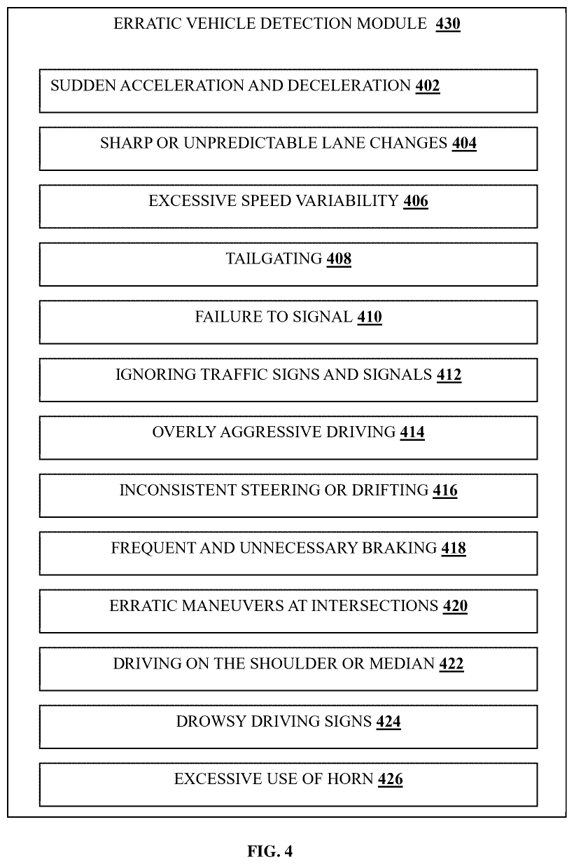

FIG. 4 shows the erratic vehicle detection module 430 with various indicators for detecting erratic behavior according to an embodiment. The system may detect a pattern that is indicative of the erratic behavior. Parameters that may be observed for determining erratic behavior comprise sudden acceleration or deceleration 402, sharp or unpredictable lane changes 404, excessive speed variability 406, tailgating 408, failure to signal 410, ignoring traffic signs and signals 412, overly aggressive driving 414, inconsistent steering or drifting 416, frequent and unnecessary braking 418, erratic maneuvers at intersections 420, driving on the shoulder or median 422, drowsy driving signs 424, excessive use of horn 426, etc. The system would increase the scanning frequency upon first instance of detection of an erratic behavior sign. Further, the sampling or scanning frequency is increased and adapted accordingly based on how the target vehicle state regarding the above parameters is evolving over time. The system uses monitoring module 304 (as shown in FIG. 3) comprising an imaging sensor, proximity sensor, radar, etc. Radar and LIDAR and other sensors that are properly configured and positioned on the vehicle may be proximity sensors that are capable of detecting nearby objects, vehicles, etc.

In an embodiment, mm Wave radar sensors can be used to detect nearby vehicles, obstacles, etc., particularly when the nearby vehicles and obstacles have sufficient reflective surfaces, such as metal parts. MmWave radar sensors operate by emitting electromagnetic waves in the millimeter-wave frequency range and then measuring the time it takes for the waves to bounce back after hitting an object. The radar sensor can analyze the reflected signals to detect and track objects in the vehicle's vicinity.

According to an embodiment, an AI-based erratic behavior detection may be used in combination with sensor fusion techniques. Several AI algorithms can effectively detect patterns indicative of erratic behavior in traffic. One commonly used algorithm is the Long Short-Term Memory (LSTM) network, a type of recurrent neural network (RNN) suitable for sequence modeling. LSTMs can analyze sequential patterns in vehicle movements over time, identifying sudden accelerations, abrupt lane changes, or irregular speed fluctuations. Another algorithm is the k-Nearest Neighbors (k-NN), which measures the similarity of a vehicle's behavior to its neighboring vehicles. Sudden deviations from the typical behavior of nearby vehicles can trigger an alert. Additionally, decision tree-based algorithms, such as Random Forests, are adept at classifying complex patterns. These algorithms consider various features like speed, acceleration, and lane positioning to discern erratic behavior. Machine learning models trained with supervised learning techniques, like Support Vector Machines (SVM), learn from labeled examples of normal and erratic behavior to classify new instances. These algorithms are trained and are operable to identify nuanced patterns and anomalies in vehicle trajectories for detecting erratic behavior on the road in real-time.

Memory 308 may be a non-volatile memory (NVM) which is crucial for the reliable operation of the system, ensuring that essential data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption.

In an embodiment, the memory may be a cloud-based memory. In another embodiment, the memory may be a local memory. In another embodiment, it may be a combination of local and cloud based memory. Local memory refers to the traditional memory components present in a physical device, such as a computer's RAM, hard disk drives (HDDs), or solid-state drives (SSDs). Local memory provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Communication module 310 functions are similar to communication module 220 as described herein in this application in relation to FIG. 2. Further, communication module 310 facilitates communication between different modules within the system, communication between vehicles on the road.

Various communication protocols can be employed for transmitting messages. Bluetooth® and Wi-Fi® are suitable for short-range communication within close proximity, while cellular communication utilizing 3G, 4G, or 5G networks allows for data transfer over longer distances. V2X protocols encompass V2V and V2I communication, enabling vehicles to share data with each other and infrastructure units. DSRC, designed for V2V and V2I scenarios, facilitates short-range communication. The selection of the communication protocol depends on factors such as range, data transfer rate, power consumption, security, and existing infrastructure.

Data collection module 312: Data collection module collects and stores user data, vehicle data, sensor data, road data, route data, etc. The user data may be collected from any of the devices that the user owns or uses. Prior permission may be taken to access such data or portions of data. In an embodiment, the vehicle system may be synchronized with the other devices of the user to access the data. User data may include name, address, home address, office address, friends, routes preferred, etc.

According to an embodiment, the system collects vehicle data. Understanding driver behavior and driving conditions is important for improving overall safety and driving experiences. To gain insights into these aspects, several types of vehicle data can be collected and analyzed. Data on distance traveled, routes taken, and braking to stop and—acceleration data provide insights into the driver's habits and their impact on energy consumption. Identifying inefficient driving patterns allows for targeted improvements to maximize the vehicle's safety margins and thus safety. The data on driving patterns and habits include acceleration, braking, and steering behaviors, providing valuable information about the driver's style and aggressiveness. Driving behaviors such as aggressive driving, rapid acceleration, and excessive braking can all help in determining safety ranges for the driver on a specific road and traffic conditions.

Additionally, sensors associated with the vehicle can collect data on weather conditions, road surfaces, and visibility, shedding light on how external factors influence driver behavior, range, and safety. According to an embodiment, the road surface condition is determined by a map showing the weather conditions. According to an embodiment, the road surface condition is determined by detecting a road condition in real-time via the computer vision module. According to an embodiment, the road surface condition is determined by analyzing a scattering of an emitted beam of light on a road surface using a filtering technique on an image that is captured by the computer vision module. According to an embodiment, the road surface condition is received via Vehicle-to-Infrastructure (V2I) or Vehicle-to-Vehicle (V2V) communication.

Speed and location data combined with GPS information offer a comprehensive view of the vehicle's movements and speed profile, helping to understand driving conditions. Further, vehicle performance data, such as engine performance and fuel efficiency, allows for an evaluation of how the driver's behavior affects the vehicle's health, safety, and overall performance. In some embodiments, driver biometric data, like eye movements and heart rate, may be collected to assess attentiveness and emotional state during different driving conditions. In an embodiment, diverse sets of vehicle data offer valuable insights into driver behavior, the impact of external factors on driving conditions, and areas for improvement to enhance vehicle safety. Privacy and security measures are provided on the data using a cyber security module. By collecting and analyzing these diverse sets of vehicle data and user data, the system may gain a comprehensive understanding of how driver behavior and driving conditions impact the safety of a vehicle.

Collision Possibility Analysis and Evasive Action Recommendation module 314: By using the data from monitoring module 304, erratic vehicle detection module 306, and data collection module 312, the collision possibility analysis and evasive action recommendation module 314 would first determine the collision possibility and accordingly recommend an evasive action.

Components of the collision possibility analysis module comprise continuous monitoring module, erratic vehicle identification module, dynamic model module, relative motion calculation module, proximity assessment module, relative speed analysis module, trajectory prediction module, trajectory intersection check module, safety threshold module, collision probability assessment module, warning intervention trigger module and continuous monitoring and adaptation module collectively contribute to a collision prediction system that can assess and respond to the dynamic environment on the road, especially in the presence of erratic vehicle behavior.

Continuous monitoring module: In order to predict the possibility of a collision of the host vehicle with surrounding vehicles and the erratic vehicle in the presence of an erratic vehicle on the road, the system continuously tracks the positions and speeds of all vehicles, with a specific focus on identifying the erratic vehicle based on its unpredictable behavior. Continuous monitoring may be performed via monitoring module 304.

Erratic vehicle identification module: The system identifies the erratic vehicle based on its unusual or unpredictable behavior. This could include abrupt lane changes, sudden accelerations or deceleration, or erratic steering. Erratic vehicles may be identified via erratic vehicle detection module 306.

Dynamic Model module: This module comprises a dynamic model that is used to predict the future positions and velocities of all vehicles. This model considers the current state of each vehicle in an area or zone and estimates how it will evolve over time. The system may also comprise regression scenarios based on the variables that may affect the collision. In an embodiment, the dynamic model module may comprise both a dynamic model and a regression model whose outputs are weighted and combined.

Relative Motion Calculation module: In an embodiment, the relative motion calculation module calculates the relative motion between each non-erratic vehicle and the erratic vehicle. This involves determining the differences in positions and velocities.

Proximity Assessment module: The proximity between the host vehicle with each non-erratic vehicle and the erratic vehicle is then calculated, along with an assessment of their relative speeds by proximity assessment module. The system assesses the proximity between vehicles by considering the relative distance and the time it would take for the vehicles to reach each other. Rapidly decreasing proximity might indicate an imminent collision.

Relative Speed Analysis module: This module analyzes the relative speeds of vehicles. A high relative speed indicates an increase in the likelihood of a collision, especially if the erratic vehicle is moving significantly faster or slower than the surrounding vehicles.

Trajectory Prediction module: The module predicts the future trajectories of each vehicle within a certain proximity based on their current state and velocities. This involves extrapolating each vehicle's path into the future. The module uses predictive analysis which aims to forecast the future states of vehicles based on their current positions, velocities, and behaviors. It involves modeling the motion of vehicles over time to anticipate their future locations, utilizing a kinematic and/or dynamic model to capture the motion of vehicles. A kinematic model focuses on position and velocity, while a dynamic model considers additional factors like acceleration and steering. The system updates predictions iteratively in real-time, factoring in the current state of the vehicle and its predicted trajectory. Trajectory prediction involves estimating the future path that a vehicle will follow based on its current state and dynamics. The module uses a dynamic model to simulate the vehicle's behavior over a short time horizon to predict the future positions at discrete time steps, considering the impact of control inputs. The system further incorporates uncertainty due to sensor noise, road conditions, or unexpected events. In an embodiment, a feedback loop is established where the predictive analysis informs the dynamic model, and the trajectory predictions feed into the collision assessment. Predictions are refined continuously based on real-time sensor data to adjust the dynamic model parameters as needed. In an embodiment, the system is integrated with machine learning algorithms to learn from historical data, improving the accuracy of predictive models and trajectory predictions.

Trajectory Intersection Check module: In an embodiment, this module checks for intersections or close approaches between the predicted trajectories of the erratic vehicle and other vehicles. If trajectories are predicted to intersect, the trajectory intersection check module signals a potential collision.

Safety thresholds module: In an embodiment, safety thresholds are defined in the system and can be adjusted based on road conditions, vehicle types, traffic conditions, and the specific characteristics of the erratic vehicle, where specific characteristics include size, weight, speed of the erratic vehicle.

Collision Probability Assessment module: In an embodiment, this module combines the assessments of proximity, relative speed, and trajectory intersections to calculate a collision probability. The collision possibility is then assessed by considering factors such as decreasing proximity, high relative speed, and potential trajectory intersections. Trajectory intersection checks aim to determine whether the predicted paths of different vehicles will intersect in the future, indicating a potential collision. The system compares the predicted trajectories of the erratic vehicle and other vehicles in the vicinity to assess whether there is spatial or temporal overlap between these trajectories. The system evaluates time to collision and spatial proximity. The system evaluates the time it would take for two vehicles' predicted trajectories to meet. If this time is too short, for example, in milliseconds to seconds, it signals a potential collision. The system evaluates the spatial separation between the predicted trajectories. If they come too close, it may indicate a collision risk. The system continuously updates trajectory predictions and conducts intersection checks as the vehicles' states change.

Predictive analysis aims to forecast the future states of vehicles based on their current positions, velocities, and behaviors. It involves modeling the motion of vehicles over time to anticipate their future locations, utilizing a kinematic and/or dynamic model to capture the motion of vehicles. A kinematic model focuses on position and velocity, while a dynamic model considers additional factors like acceleration and steering. The system updates predictions iteratively in real-time, factoring in the current state of the vehicle and its predicted trajectory. Trajectory prediction involves estimating the future path that a vehicle will follow based on its current state and dynamics. The system uses a dynamic model to simulate the vehicle's behavior over a short time horizon and predicts the future positions at discrete time steps, considering the impact of control inputs. The system further incorporates uncertainty due to sensor noise, road conditions, or unexpected events. In an embodiment, a feedback loop is established where the predictive analysis informs the dynamic model, and the trajectory predictions feed into the collision assessment. Predictions are refined continuously based on real-time sensor data and adjusting the dynamic model parameters as needed. In an embodiment, the system is integrated with machine learning algorithms to learn from historical data, improving the accuracy of predictive models and trajectory predictions.

Warning or Intervention Trigger module: If the collision probability exceeds/surpasses defined thresholds, the module triggers warnings to drivers or initiates collision avoidance mechanisms, such as emergency braking, steering interventions, or signaling to nearby vehicles.

Continuous Monitoring and Adaptation module: This module continuously updates the predictions and assessments as vehicles move. It further adapts safety thresholds dynamically based on real-time conditions.

The system continuously monitors and updates the predictions to ensure an adaptive and dynamic approach to collision prediction on the road. In an embodiment, the logic for collision avoidance systems is integrated into assistance systems (ADAS) and autonomous vehicle technologies.

A predictive analysis is conducted to estimate the future positions of all vehicles based on their current trajectories and speeds. Predictive analytics, for collision possibility analysis, integrates real-time data. The model continuously incorporates up-to-date information on weather conditions, traffic patterns, road conditions, and other relevant factors, ensuring that the predictions are adaptive and responsive to dynamic driving conditions. Predictive analytics models continuously learn. As new data becomes available, the model may update and refine its predictions, maintaining accuracy over time and adapting to changes in the vehicle's performance, road conditions, traffic conditions and various driving patterns. By combining historical data, real-time information, and advanced machine learning techniques, collision possibility analysis, using predictive analytics, is provided. This empowers drivers to make informed decisions, regarding evasive actions, to avoid potential collisions.

Evasive action recommendation is provided for the host vehicle via the alert system. In an embodiment, the host vehicle determines the corrective/evasive actions to take. Evasive actions may include one of getting off the road, changing a lane, moving in reverse, reducing speed, increasing speed, taking an alternate route, requesting the other vehicles to get out of the way so that the host vehicle can move out of the way.

In an embodiment, the host vehicle provides evasive action recommendations for the nearby vehicles. In an embodiment, the host vehicle establishes communication with nearby vehicles. In an embodiment, the host vehicle scans for the erratic vehicle and its location and transmits the message of the location and the type of vehicle to the other surrounding vehicles. For the host vehicle to know more precisely, it starts scanning to see how many other vehicles can be informed about the situation so that the host vehicle and the other vehicles can take corrective actions.

In an embodiment, the system of the host vehicle predicts a score of likelihood of impact with the erratic vehicle and based on the score, requests the other vehicles to give way to the host vehicle by sending customized/individualized request messages. For example, for a vehicle that is behind the host vehicle, a request to move back six feet; and for a vehicle that is ahead of the host vehicle, a request to move forward six feet, to make way to move out of the lane. In an embodiment, the information can be relayed, meaning that if all vehicles are capable of communicating with each other, then all the vehicles talk to each other and may clear a path to avoid congestion and/or potential collision.

In an embodiment, the decision for communication regarding the movement of vehicles is made using swarm intelligence. In an embodiment, a swarm algorithm is implemented to manage and alleviate traffic congestion on roads due to erratic vehicles. Swarm intelligence is an approach inspired by collective behavior observed in nature. The concept draws from swarm intelligence, where decentralized agents, modeled after social organisms like ants or birds, work together to solve complex problems. In the current context of road congestion or erratic driving and potential collision, a swarm algorithm is designed to optimize traffic flow, to prevent or alleviate a situation, and to avoid any possible contact with the erratic behavior vehicle.

Implementing a swarm intelligence utilizes communication infrastructure, vehicle-to-everything (V2X) technologies, and a computational framework. Additionally, privacy and security considerations are addressed using the cybersecurity module. Swarm intelligence involves collaboration between the host vehicle and other surrounding vehicles on the road to avoid encounters of certain vehicles or certain areas and to steer away from potential collisions. Host vehicles are equipped with this feature to warn other vehicles of erratic vehicles, hazardous spots such as fog or black ice, and to report current speed limits.

Swarm intelligence comprises the following steps:
i) Decentralized Decision-Making: Each vehicle on the road acts as an autonomous swarm agent with the ability to communicate with nearby vehicles. Agents make decentralized decisions based on local information, such as vehicle speed, distance to neighboring vehicles, and traffic conditions.
(ii) Traffic flow monitoring and Information Sharing: Vehicles share real-time information about their current position, speed, and intended direction with nearby vehicles. Communication can occur through vehicle-to-vehicle (V2V) or vehicle-to-infrastructure (V2I) technologies.
(iii) Dynamic Route Optimization: Swarm algorithm analyzes the collective data to identify areas of congestion or potential congestion. Vehicles dynamically adjust their routes in response to real-time traffic conditions to distribute the traffic load more evenly.
(iv) Event/Anomaly Detection: The algorithm identifies events such as vehicle pursuit, high-speed chases, erratic driving behavior, emergency vehicle proximity, and accident zones, etc. Anomaly detection mechanisms analyze vehicles' behaviors against predefined patterns. Anomaly detection by the host vehicle may be communicated to the other vehicles that may be prone to similar situations like that of the host vehicle.
(v) Response Coordination: In the event of anomaly (ex. a high-speed chase/vehicle pursuit or erratic driving etc.), the system triggers a coordinated response. Nearby vehicles receive alerts to clear the path and create a safe corridor for host vehicles/groups of vehicles to mitigate/evade the impact of erratic driving.
(vi) Adaptive Speed Control: Vehicles adjust their speeds adaptively based on the information received from the swarm intelligence. Adaptive speed control helps maintain a smooth and efficient flow of traffic, reducing the likelihood of congestion or a likelihood of impact or contact with the erratic vehicle.
(vii) Coordinated Traffic Signals: Integration with traffic signal systems allows the swarm intelligence to optimize signal timings based on the current and predicted traffic conditions. Coordinated signals can help facilitate the movement of traffic through intersections more efficiently avoiding any congestion while evading the erratic vehicle.
(viii) Emergency Response Integration: The algorithm considers emergency vehicles, law enforcement vehicles, giving them priority and dynamically adjusting traffic patterns to ensure swift passage.
(ix) Learning and Adaptation: The swarm intelligence may be aided by machine learning to adapt and improve its performance over time based on historical traffic patterns, historical data, and user behavior. The system adapts to evolving traffic patterns, erratic behavior scenarios, emergency scenarios, and user behaviors.

Increased contact zone: In an embodiment, the system not only scans and determines a single erratic vehicle but also analyzes for the presence of other similar vehicles such as a group of vehicles that are erratic or an erratic vehicle being pursued by law enforcement agency vehicles. The system scans for erratic behavior even from a distance and looks for the drivers exhibiting reckless driving. In an embodiment, the system detects multiple vehicles involved in a vehicle pursuit. In such situations, the risk is heightened as the contact zone, defined as the area of potential impact or collision, expands with each additional pursuing vehicle. When analyzing the potential danger, the contact zone of a single vehicle (denoted as x) increases when multiple vehicles involved around the erratic behavior are detected. Notably, there are instances abound where law enforcement vehicles have collided with erratic vehicles or other neighboring vehicles while chasing a suspect/erratic vehicle. The system therefore looks for the expanded contact zone. Therefore, the system aims not just to detect and identify erratic behavior in one vehicle but to assess the impact of multiple vehicles in the contact zone. The more vehicles involved, the greater the contextual challenge. So, the system not only identifies erratic behavior but also the potential consequences of a larger contact zone when multiple vehicles are involved in such situations.

Alert signal and message generation module 316: Alert signal and message generation module 316 ensures that the host vehicle possesses the capability to both send and receive messages. When a message is received, the vehicle needs the capacity to process it. In order to address the message received by various vehicle types, the message may be in a standardized message format. In an embodiment, messages can vary in length and content.

In an embodiment, the message comprises a notification that communicates the presence of an erratic vehicle. In an embodiment, the message would further comprise details such as an alert, the erratic behavior vehicle's ID, and a description of the vehicle. At its basic level, the notification would convey the location of the erratic behavior. Additionally, the message may further comprise that the erratic vehicle's contact zone involves not just one but multiple vehicles, allowing the host vehicle as well as the nearby vehicles to make informed decisions about the expanded contact zone.

The message is standardized such that it facilitates the processing of this information uniformly across different vehicle types. Within the messaging component, there is a distinct sequence of messages, specifying the nature of messages transmitted and the content of the exchanges between the host vehicle and its surroundings. Two types of communication can occur: one involving the host vehicle and the erratic vehicle it is engaging with, and the other involving neighboring vehicles to the host vehicle.

In an embodiment, initial level or level one notifications signal the presence of an erratic behavior driver, serving as the primary alert. This message may be broadcast to all the neighboring vehicles. There could be further broadcast of messages which include various details on erratic driven vehicle such as a photo, driver information, vehicle color, type, model, weight category, size category etc. In a further exchange, the message may also include the contact zone information, indicating the proximity within which potential danger exists, say, for example within 50 feet from the erratic vehicle location.

Moreover, the system is adaptive, allowing for subsequent messages to provide additional information. For instance, if emergency vehicles join the situation, a follow-up message incorporating the initial data and appending new details may be transmitted. This dynamic messaging approach ensures the continuous enhancement of situational awareness.

Beyond these notifications, there is a separate category of messages dedicated to communication between individual vehicles. This communication can either be integrated into the existing message stack or treated as an independent communication stream. For example, a distinct message could convey guidance from one vehicle to another, suggesting actions such as moving to the right, exiting the freeway, or adjusting lateral position. This message would encapsulate relevant information, including the source, the nature of the communication, and any additional details related to the erratic behavior. In essence, if your vehicle receives a message from another vehicle, it can decipher the content, relay a message, providing a comprehensive understanding of the communicated information.

In an embodiment, messages are exchanged between a host vehicle and nearby vehicles. The message may comprise information on what type of a vehicle is the erratic vehicle, size, shape, weight of the erratic vehicle, driver of the erratic vehicle. In an embodiment, the message may comprise visual photos that can be exchanged. In an embodiment, a message indicating a specific course of action is transmitted. In this communication, the message specifies the direction the vehicle ought to steer clear of to avoid the erratic vehicle. The host vehicle may inform not just the presence of erratic behavior but also relay images captured by its cameras to alert other vehicles.

In an embodiment, the message is a broadcast sent to all vehicles in the vicinity of the host vehicle providing a general alert about erratic behavior. In contrast, when the host vehicle receives a message from another specific vehicle, it not only contains the initial broadcast message but also includes additional directives such as road conditions, traffic around, etc. This personalized message instructs the host vehicle on specific actions to take, such as moving to the right or left, or adjusting the vehicle's position by a few feet. Essentially, these messages carry actionable steps provided by the communicating vehicle, acknowledging that it possesses information about the immediate road conditions and context, unlike the general broadcast.

In the broader context, if a vehicle is in the vicinity or in a route that is having an erratic vehicle, the vehicle's role extends beyond receiving notifications; it may have the capability to broadcast information. As part of this reciprocal communication, vehicles can share additional details such as road conditions, proximity to other vehicles, or challenges like being on a difficult road or having limited space to maneuver. This enhanced interaction between vehicles prompts consideration of the information one would desire if involved in a similar situation. Consequently, the messaging framework encompasses comprehensive information that includes various anti-collision elements. These elements comprise information about erratic drivers, directional guidance, and actions that need to be taken or requested from other vehicles. Essentially, the message is bifurcated into two aspects: one where the vehicle must be equipped to receive incoming messages and another where it has the ability to transmit messages during vehicle-to-vehicle communication (V2V) and or vehicle-to-Everything communication (V2X).

Essentially, there will be two parallel streams of communications. One involves receiving a message, understanding the necessary actions, and executing them. The other scenario pertains to the content of the actual message itself. In an embodiment, the content of the message is standardized, transcending the specifics of vehicle make or model. In an embodiment, the message communication between vehicles ensures that, regardless of the manufacturer of the vehicle, there is a common protocol for exchanging and decoding the information.

In this specific case, the envisioned messaging structure comprises receiving an initial notification, labeled as message of level one, indicating the presence of an erratic driver. This message, which includes details about the location, driver type, and related information, can originate from both external broadcasts and the vehicle itself. However, when the message is from the vehicle, an added dimension is introduced: the ability to convey directional guidance. This directional guidance could be a response to an action required by the recipient, such as acknowledging that the advised action will be taken, like moving three feet backward or shifting to the right.

Moreover, the message from the vehicle might not only prompt a specific action but also provide suggested routes to avoid potential hazards. In this case, the process of constructing such messages follows the same principles of standard format. The underlying objective is to establish a robust messaging framework that caters to both receiving and transmitting pertinent information between vehicles in a standardized manner.

Another aspect is the incorporation of the requested action information into a vector net. Vector net could provide a directional indicator, specifying the necessary course, be it a 30-degree vector, 180-degree vector, or 90-degree vector, for instance. Including these details in the message that is transmitted to a nearby vehicle to give directional information may provide more clarity for the nearby vehicle driver. In an embodiment, the message comprises information related to potential threats posed by erratic drivers, and also a dedicated/separate section to the specific actions requested by the communicating vehicle. This ensures a clear and comprehensive delineation of the different components within the messaging framework.

According to an embodiment of the system, the message comprises a request for the nearby vehicle to move in a specific direction. In an embodiment, the direction is specified as a vector net. According to an embodiment of the system, the evasive action comprises requesting the nearby vehicle to one or more of adjusting a distance from the host vehicle, a lane change, a reverse maneuver, and a change in a route.

In the V2X communication, other vehicles report incidents, for example, a message indicating, “On Highway X, and there is a specific vehicle AB 1234 exhibiting erratic driving behavior.” This information is then communicated to all vehicles in the vicinity, providing a comprehensive and real-time understanding of the road conditions.

Additionally, the system considers the presence of emergency vehicles such as ambulances. If these vehicles are approaching a user's vehicle, the system advises the user to be cautious and avoid the area they are entering. The system proactively monitors the surroundings and, upon detecting an erratic driver or potential danger, alerts the user. Furthermore, the system has the capability to suggest alternative routes to steer clear of the identified risky situation. The system is operable for evading contact with erratic drivers, encompassing various scenarios such as ambulances, police vehicles, fire trucks, and even reckless drivers or fleeing criminals. The system provides timely warnings and, when necessary, proposes alternative routes to help users take evasive actions.

In an embodiment of V2X communication messaging, the emphasis is on a system proficient in receiving comprehensive information about erratic drivers. This encompasses details such as the driver's location, the degree of erratic behavior, and specific vehicle identification, including the license plate number and type (e.g., police vehicle, ambulance, SUV etc.). Erratic behavior, depending on the danger it is causing, may be classified into categories of mild, moderate, aggressive, potentially dangerous, immediate attention required etc. The classification is based on various patterns and severity of the erratic driving and the degree of risk posed. Erratic driving details can be obtained through two primary channels: monitoring traffic reports and receiving information directly from other vehicles, whether they are a few vehicles ahead or have recently traversed the same route. The system is operable for both transmitting and receiving messages via V2X messaging.

In an embodiment, the system is operable for transmission and reception of data and the ensuing actions. In an embodiment, the system delves into the transmission and reception of information. For instance, when an erratic driver is identified, the system compiles relevant information, such as capturing an image of the vehicle, and then transmits this compiled data through broadcasting to the surrounding vehicles, focusing on the actual messaging process. Furthermore, the system possesses the capability to receive content, including images, license plate numbers, and details about the type of erratic driving, such as distinguishing a police vehicle from the erratic vehicle etc.

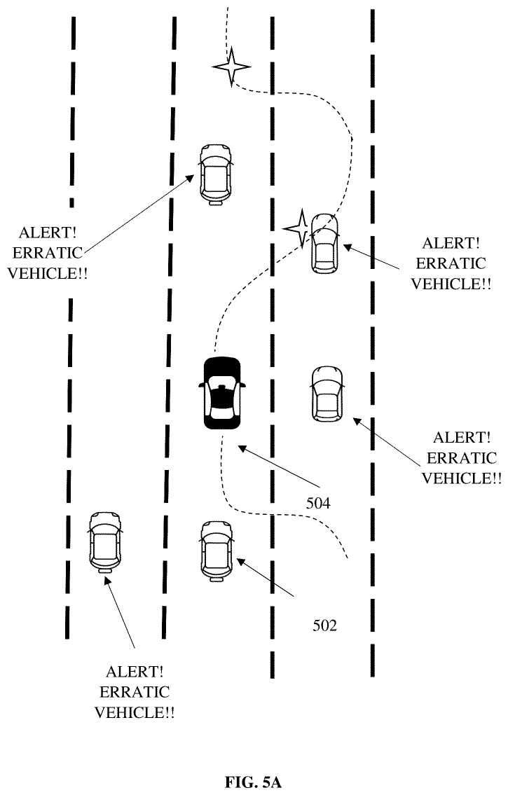

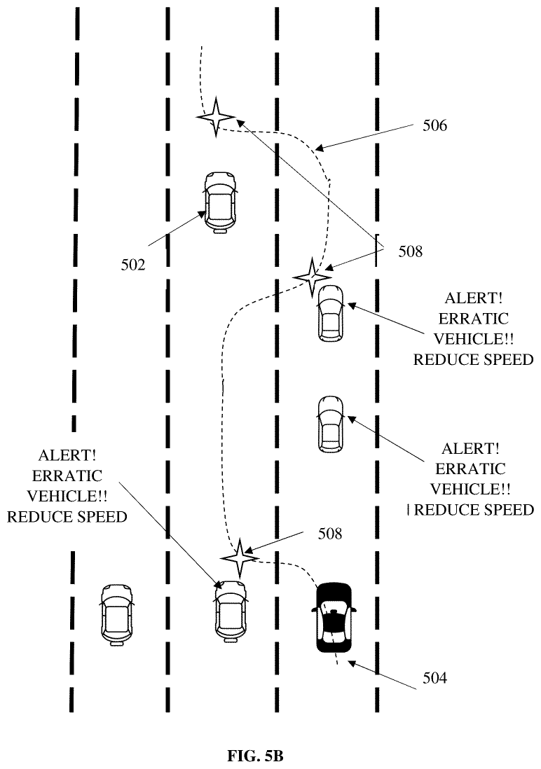

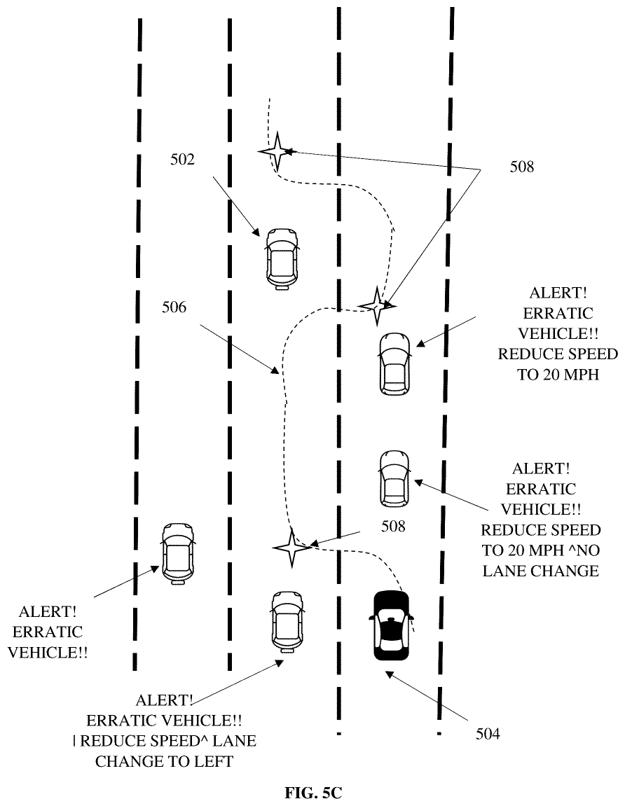

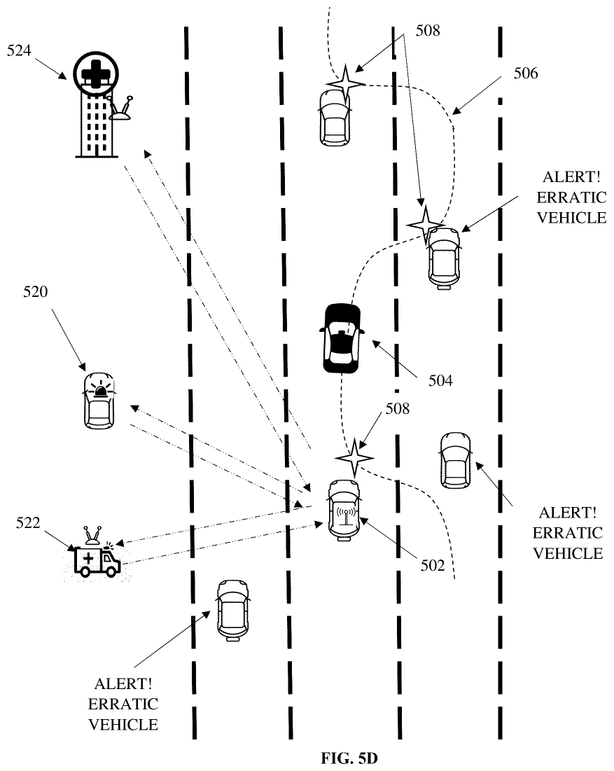

FIG. 5A shows a broadcast of a message to all the nearby vehicles upon detection of an erratic vehicle according to an embodiment. The system of a host vehicle 502, upon identifying an erratic behavior in a vehicle 504, may classify the vehicle as erratic vehicle 504. The system of the host vehicle may trigger an alert signal to the driver on an infotainment system of the host vehicle. In an embodiment, the message may be sent to the surrounding/nearby vehicles or any user device present in the nearby vehicles. It may automatically broadcast a message to all the nearby vehicles, within a certain range, to inform them that an erratic vehicle is present on the route. The message may alert the nearby vehicle drivers and prompt for an action voluntarily. The nearby vehicles may include autonomous vehicles, semi-autonomous vehicles, and driver-based vehicles. The host vehicle may automatically find an evasive action which comprises one or more of changing a lane, reducing speed, a pull over and complete stop, changing route. In an embodiment, a corresponding message is broadcast to the plurality of nearby vehicles. In an embodiment, a driver of the vehicle performs a recommended evasive action. In an embodiment, a recommended evasive action is instructed to a driver of the vehicle with at least one of a voice instruction or by displaying the instruction on a display of the vehicle. In an embodiment, a recommended evasive action is performed in an autonomous mode of the vehicle. In an embodiment of the system, the system detects a nearby vehicle, based on at least one of an infrared sensor, an ultrasonic sensor, a radar sensor, a passive acoustic detector array, a piezoelectric sensor, a photoelectric sensor, and an image sensor. In an embodiment, the message to the nearby vehicles comprises details about the erratic vehicle wherein the details comprise one or more of an erratic vehicle identification, license plate number, a color, a size, a type, make and model, a weight, a location, a heading direction, a lane number, speed of the erratic vehicle etc.

According to an embodiment of the system, the system is operable for broadcasting the message. According to an embodiment of the system, the message further comprises a noticeable feature of the erratic vehicle, wherein the noticeable feature comprises one or more of a bumper sticker, a dent, and any special accessory attached to the erratic vehicle. According to an embodiment of the system, the message further comprises a request for a daisy chain communication to notify other surrounding vehicles within a geographical range or a route of the nearby vehicle. According to an embodiment of the system, the message further comprises an image of the erratic vehicle. According to an embodiment of the system, the message further comprises an image of a driver of the erratic vehicle and passengers of the erratic vehicle.

FIG. 5B shows a broadcast of a message to a group of nearby vehicles upon detection of an erratic vehicle according to an embodiment. The system of the host vehicle 502, upon identifying the erratic vehicle 504 based on the erratic behavior, may trigger the alert signal to the driver of the host vehicle on an infotainment system. The host vehicle may identify the erratic vehicle based on 360 degree vision. Therefore, the host vehicle may be ahead of the erratic vehicle and still identify the erratic behavior before it encounters it. In an embodiment, the host vehicle 502 may detect the erratic path followed by the erratic vehicle and predict a next segment of the erratic path 506. In an embodiment, based on the current speed, location, acceleration data of nearby vehicles, the host system may also predict the possibility of collision and possible collision points 508. The host vehicle may automatically broadcast a message to a section of the nearby vehicles or selected nearby vehicles. For example, the system of the host vehicle may automatically alert all the vehicles that are in the same lane and the right side lanes to the host vehicle where the erratic vehicle may pass comprising a request to reduce speed. In an embodiment, the erratic vehicle's possible collision points 508 are based on finding out the speed of the nearby vehicles and the real time location of the nearby vehicles and computing the intersection of predicted segments of the erratic vehicle path 506 with the predicted path of the nearby vehicles. The message may alert the nearby vehicle drivers and prompt for an action voluntarily, such as reducing the speed by the drivers of the nearby vehicles. The nearby vehicles may include autonomous vehicles, semi-autonomous vehicles, and driver-based vehicles. In an embodiment a nearby vehicle comprises at least one of a car, a truck, a van, a motorcycle, a bus, a trailer, and a construction vehicle. In an embodiment the vehicle senses the speed of a nearby vehicle for determining the possible collision points and transmits a message with an instruction for speed, and an instruction for a course to the nearby vehicle. In an embodiment the message is individualized for the nearby vehicle. In an embodiment a required speed of the nearby vehicle is estimated using a dedicated short-range communication by obtaining a distance between the erratic vehicle, host vehicle, and a nearby vehicle. In an embodiment a nearby vehicle is in proximity and within a communication range of the vehicle.

FIG. 5C shows transmission of a customized message to the nearby vehicles upon detection of an erratic vehicle according to an embodiment. The system of the host vehicle 502, upon identifying the erratic vehicle 504 based on the erratic behavior, may trigger the alert signal to the driver of the host vehicle on an infotainment system. The host vehicle may identify the erratic vehicle based on 360 degree vision. Therefore, the host vehicle may be ahead of the erratic vehicle and still identify the erratic behavior before it approaches. In an embodiment, the host vehicle 502 may detect the erratic path followed by the erratic vehicle and predict a next segment of the erratic path 506. In an embodiment, based on the current speed, location, acceleration data of nearby vehicles, the host system may predict the possibility of collision and possible collision points 508. The host vehicle may automatically transmit a message to a section of the nearby vehicles or selected nearby vehicles. For example, the system of the host vehicle may automatically alert all the vehicles that may possibly encounter the erratic vehicle. In an embodiment, the erratic vehicle possible collision points 508 are based on finding out the speed of the nearby vehicles and the real time location of the nearby vehicles and computing the intersection of predicted segments of the erratic vehicle path 506 with the predicted paths of the nearby vehicles. The message may alert the nearby vehicle drivers and prompt for an action, such as reducing the speed by the drivers of the nearby vehicles The individualized or customized message comprises an instruction for speed and an instruction for course that is specific to each vehicle which are computed based on the location of the nearby vehicles and/or erratic vehicle path and possible collision points. In an embodiment the message is a customized message for each of the plurality of nearby vehicles based on the location of each nearby vehicle. In an embodiment the instruction for speed comprises at least one of a reduction in speed, maintenance of speed, an increase in speed, and complete stop. In an embodiment the instruction for course comprises at least one of a lane keeping, a lane changing, a pull over to a side of a road, and a change in the route. In an embodiment, the host vehicle is operable for a two-way communication with nearby vehicles. In an embodiment, the message can be sent to the nearby vehicles at a time T=t1, and the nearby vehicles may message or communicate their new speed at time T=t2. Further, when the host vehicle finds the nearby vehicle too close, violating the safety thresholds at time T=t2, it may further communicate to the nearby vehicle to further reduce its speed. Thus, the user's vehicle and nearby vehicles may continue to communicate until they maneuver or come out of the contact zone of the erratic vehicle. In an embodiment the alert signal/message comprises at least one of a text message, a display, a sound, a light, and a combination thereof.

FIG. 5D shows transmission of a message to law enforcing agency and emergency services upon detection of an erratic vehicle according to an embodiment. The system of the host vehicle 502, upon identifying the erratic vehicle 504 based on the erratic behavior, may trigger the alert signal to the driver of the host vehicle on an infotainment system. In an embodiment, the host vehicle 502 may detect the erratic path followed by the erratic vehicle and predict a next segment of the erratic path 506. In an embodiment, based on the current speed, location, acceleration data of nearby vehicles, the host system may also predict the possibility of collision and possible collision points 508. The host vehicle may automatically transmit a message to a group of the nearby vehicles or selected nearby vehicles. For example, the system of the host vehicle may automatically alert all the vehicles that may possibly encounter the erratic vehicle. In an embodiment, the erratic vehicle's possible collision points 508 are based on finding out the speed of the nearby vehicles and the real time location of the nearby vehicles and computing the intersection of predicted segments of the erratic vehicle path 506 with the predicted path of the nearby vehicles. The message may be a general broadcast message comprising an alert for an erratic vehicle or alert the nearby vehicle drivers and prompt for an action, such as reducing the speed by the drivers of the nearby vehicles. The individualized or customized messages comprise an instruction for speed and an instruction for course that is specific to each vehicle which are computed based on the location of the nearby vehicles and/or erratic vehicle path and possible collision points. When the host vehicle determines that collision with the erratic vehicle is imminent for either the host vehicle or the nearby vehicles, the host vehicle sends a message to one or more of law enforcing agency 520, emergency services 522, and a hospital 524 in the proximity. In an embodiment, a message may be sent to one or more of law enforcing agency 520, emergency services 522, and a hospital 524 which is in the proximity when the host vehicle determines that there is an erratic vehicle, and the collision probability is yet very low or nil. The message may comprise one or more of details of the erratic vehicle, location specified in latitude and longitude, nearby landmarks, heading direction of the erratic vehicle, images of the erratic vehicle, speed and acceleration of the erratic vehicle, degree or severity of erratic driving, and possibility of collision.

According to an embodiment of the method, the method further comprises sending an alert message to a law enforcement agency about the erratic vehicle. According to an embodiment of the method, the alert message comprises one or more of a license plate number, a make and model, a color, a location of the erratic vehicle, and a direction of travel of the erratic vehicle. According to an embodiment of the method, the method further comprises sending an alert message to the erratic vehicle, wherein the alert message comprises a request for a corrective action.

According to an embodiment of the system, the system further sends an alert message to a law enforcement agency about the erratic vehicle. According to an embodiment of the system, the alert message comprises one or more of a license plate number, a make and model, a color, a location of the erratic vehicle, and a direction of travel of the erratic vehicle. According to an embodiment of the system, the system further sends an alert message to the erratic vehicle, wherein the alert message comprises a request for corrective action.

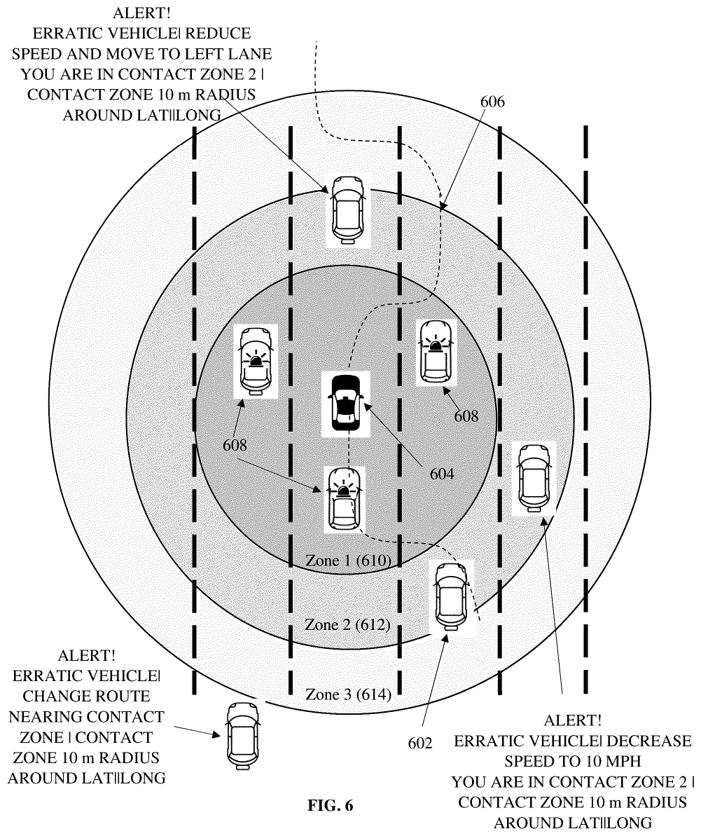

FIG. 6 shows the contact zones around the erratic vehicle according to an embodiment. In an embodiment, the region around the erratic vehicle 604, which is having or showing erratic behavior, is divided into a plurality of zones or a plurality of regions, zone 1 as shown at 610, zone 2 as shown at 612, and zone 3 as shown at 614. The surrounding region of the erratic vehicle 604 is classified into zones of contact, namely high contact zone, zone 1, medium contact zone, zone 2, low contact zone, zone 3. These zones evolve both in shape and size as the erratic vehicle 604 makes its way forward and as time passes. According to an embodiment, zones of contact are circular. In an embodiment, zones of contact could be linear extending on one side of the vehicle, for example right side of the erratic vehicle as the erratic vehicle may seem to zoom in and zoom out of the right lanes. The zones of contact may be based on one or more of the erratic behavior patterns of the erratic vehicle 604, possibility of collision in each zone, and the presence of vehicle pursuit attempts by law enforcing vehicle 608. Zones of contact may be defined by a distance measure in a vector form or a radius measure from the location of an erratic vehicle. In an embodiment, the zones of contact are based on vehicle density around the erratic vehicle. A message communicated from the host vehicle 602, regarding the emergency and the request, may be specific to a zone of contact and common to all the vehicles in the zone of contact. In an embodiment, the message may be specific to a zone of contact and individualized to the vehicles in the zone of contact based on their location. For example, vehicles in zone 2 and zone 3 may receive a message comprising a zone they are in, and an action requesting for a change in a speed or a change in a course, and information about the contact zone. In an embodiment, the vehicles that are outside of the contact zone may be warned how close they are and an action for the vehicle to avoid coming in contact with the contact zone. The alert message may comprise a request or advice to change their planned route to a new one to avoid coming in contact with the erratic vehicle.

Display module 318 in the vehicles is connected to the alert system through the vehicle's onboard computer or electronic control unit (ECU) according to an embodiment. The alert system constantly monitors various parameters related to the erratic driving and provides timely alerts. These warning/alert signals are then sent to the display module, which is responsible for presenting essential information to the driver on the vehicle's dashboard or instrument cluster.

The connection between the alert system and the display module is established through a communication network within the vehicle. Modern vehicles use Controller Area Network (CAN) or other communication protocols to transmit data between different electronic components, including the alert system and the display module.

Once the warning signal reaches the display module, it activates the appropriate visual and audible alerts to inform the driver about the erratic vehicle. In an embodiment, the display module may generate pop-up alerts on the infotainment or navigation screen, providing more detailed information about the erratic driving and potential solutions, such as suggesting an alternate route to avoid contact with the erratic vehicle. Furthermore, the vehicle may be equipped with haptic feedback capabilities, the display module can trigger haptic alerts, such as gentle vibrations in the steering wheel or seat, to provide an additional tactile cue to the driver.

The integration of the alert system with the display module ensures that drivers receive timely and accurate information about erratic vehicle status. It empowers drivers to make informed decisions and plan their routes accordingly to avoid erratic vehicles. In an embodiment the message comprises generating an alert in the vehicle, wherein the alert is at least one of a text message, a visual cue, a sound alert, a tactile cue, and a vibration.

According to an embodiment of the system, the system is operable to determine a contact zone created by the erratic vehicle, wherein the contact zone comprises one or more of a group of surrounding vehicles that are moving at a speed below a threshold speed, group of surrounding vehicles that are moving at a speed above a threshold speed, and group of surrounding vehicles that are moving within threshold speed limits. According to an embodiment of the system, the threshold speed is determined based on a speed limit on a route on which the erratic vehicle is traveling and an average speed of vehicles which are away from the erratic vehicle. According to an embodiment of the system, the contact zone comprises one or more vehicles involved in a vehicle pursuit. According to an embodiment of the system, the message further comprises one or more images of the contact zone created by the erratic vehicle, and a zone around the erratic vehicle comprising the contact zone.

According to an embodiment of the system, the message further comprises one or more images of a contact zone created by the erratic vehicle. According to an embodiment of the system, the contact zone comprises a group of surrounding vehicles that are moving at a speed below a threshold speed. According to an embodiment of the system, the threshold speed is determined based on a speed limit on a route on which the erratic vehicle is traveling and an average speed of vehicles which are away from the erratic vehicle. According to an embodiment of the system, the contact zone comprises an area where one or more vehicles are involved in a vehicle pursuit.

According to an embodiment of the system, the first message further comprises an image of the erratic vehicle. According to an embodiment of the system, the first message further comprises an image of a driver of the erratic vehicle and of passengers of the erratic vehicle. According to an embodiment of the system, the first message further comprises one or more images of the first contact zone created by the erratic vehicle. According to an embodiment of the system, the first contact zone comprises areas where a group of surrounding vehicles are moving at a speed at least one of above a first threshold speed and below a second threshold speed. According to an embodiment of the system, the threshold speed is determined based on a speed limit on a route on which the erratic vehicle is traveling and an average speed of vehicles which are away from the erratic vehicle. According to an embodiment of the system, the first contact zone comprises areas where one or more vehicles are involved in a vehicle pursuit.

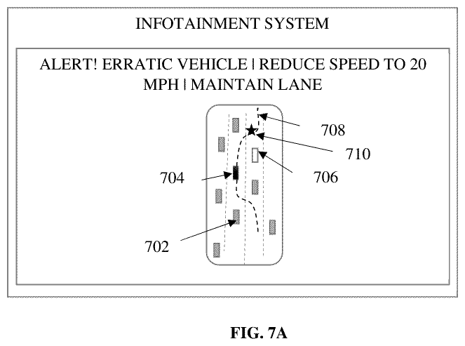

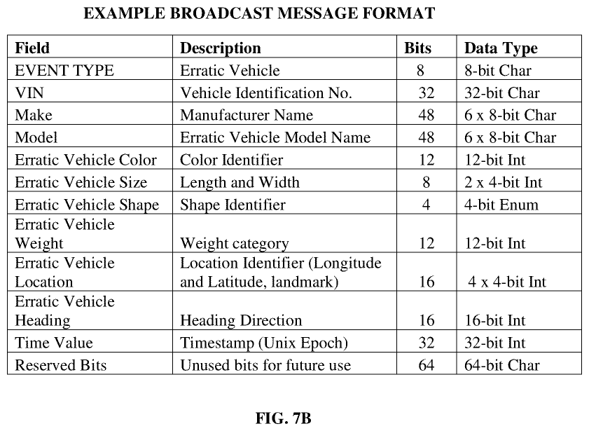

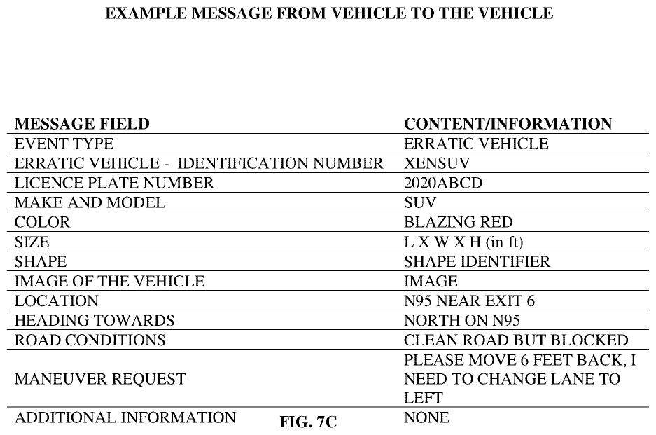

FIG. 7A shows a transmitted message or a communication message that is transmitted to a nearby vehicle displayed on an infotainment system of the nearby vehicle which includes a graphic that is generated according to an embodiment. When the host vehicle 702 transmits an alert message for identified erratic vehicle 704 to the nearby vehicle 706, the nearby vehicle 706 identifies such message and a map of the location of the surrounding vehicles, including the vehicle 706, receiving the message and possible heading profile 708 of the erratic vehicle. Possible collision points 710 are depicted in a graphical format for better understanding of the surroundings of the vehicles receiving the message. The graphic also shows host vehicle 702, erratic vehicle 704, nearby vehicles 706, possible heading profile 708 of the erratic vehicle, and possible collision points 710 to provide a clear depiction of the surroundings of the vehicle or the traffic around the vehicle. In an embodiment, the nearby vehicle decodes the message of location sent by the host vehicle and maps it. In another embodiment, the information required for mapping may be obtained by the nearby vehicle using its own sensors. In an embodiment the message is displayed on the infotainment system of the nearby vehicle. In an embodiment, the zones of contact are also depicted in the graphic.

According to an embodiment of the system, the system is further operable to display an action to a driver of the host vehicle. According to an embodiment of the system, the system is further operable to display the message to a driver of the nearby vehicle.

FIG. 7B shows an example broadcast message when an erratic vehicle is detected according to an embodiment. It may comprise elements that relate to erratic vehicles. To prepare a compact message for conveying erratic vehicle alert and erratic vehicle details, a binary encoding scheme, where each item is allocated a specific number of bits, may be used. The number of bits allocated to each item will depend on the range and precision required for that particular attribute. FIG. 7B shows an example field and allocation of bits according to an embodiment. In this example, each field in the message has a specific number of bits allocated to it:

Event Type classifies what kind of event the alert is for, and the files may use 8-bit characters. The Vehicle Identification Number (VIN) field uses 32 bits (32 characters, each represented by an 8-bit ASCII code) to represent the Vehicle Identification Number, a unique identifier for the vehicle. Make uses 48 bits (6 characters, each represented by an 8-bit ASCII code) to specify the manufacturer's name. Model uses 48 bits (6 characters, each represented by an 8-bit ASCII code) to specify the erratic vehicle's model name.

Erratic Vehicle Size field uses 8 bits (4 bits for length and 4 bits for width) to represent the size in meters or feet. The Erratic Vehicle Shape field uses 4 bits to represent a shape identifier, where different shape codes can be assigned to various vehicles based on their weight and area they occupy on the road (e.g., small, medium, big, etc.). The Weight field uses 12 bits to represent the erratic vehicle's weight in kilograms or pounds, accommodating a range of weight values. The Erratic vehicle location field uses 4×4 bits to represent the erratic vehicle's location in latitude and longitude. The erratic vehicle heading uses 16 bits to represent the erratic vehicle's heading direction. The Time Value field uses 32 bits to represent the timestamp using Unix Epoch format, indicating when the message was generated. The Reserved Bits are bits set aside for potential future use or additional attributes that may be added to the message format later. The reserved bits may further be used for speed of the erratic vehicle, landmarks nearby etc.

Message fields and allocation of bits are for example and a hypothetical representation for demonstration. In implementations, the fields, actual message format, and the number of bits allocated to each item may vary based on the specific requirements and constraints of the application and communication protocol used.

In an embodiment, the message can be tailored to basic information comprising an erratic vehicle and its identification number along with its location. In an embodiment, the message is similar to HL7 protocol. In an embodiment, the message to the nearby vehicle comprises the alert signal with a request for at least one of an instruction for speed and an instruction for a course for the nearby vehicle. The alert signal includes information on erratic vehicles. In an embodiment, the message is broadcast to all the vehicles.

According to an embodiment of the system, the system is operable for broadcasting the message. According to an embodiment of the system, the message comprises the identity of the erratic vehicle, wherein the identity comprises one or more of a vehicle identification number, a license plate number, a make and model, a color, and a noticeable feature. According to an embodiment of the system, the noticeable feature comprises one or more of a bumper sticker, a dent, and an accessory attached to the erratic vehicle. According to an embodiment of the system, the message comprises a location of the erratic vehicle and a direction of travel of the erratic vehicle.

According to an embodiment of the system, the message further comprises a request for a daisy chain communication to notify other surrounding vehicles in a geographical range. Daisy chain communication refers to communication happening in series, one after the other. The transmitted or broadcasted signals/message go to a first group of vehicles within the range of host vehicle's network, then the first group vehicles or subgroup of the first group of vehicles transfer the message to a second group of vehicles increasing the reachability of the message. The message may further be transmitted to the next group of vehicles ensuring that the vehicles, even when they are far from erratic vehicles actual location, get the message in advance and plan their course of action to avoid the erratic vehicle and the route in which the erratic vehicle is travelling.

According to an embodiment of the system, the message further comprises an image of the erratic vehicle. According to an embodiment of the system, the message further comprises an image of a driver of the erratic vehicle and passengers of the erratic vehicle.

FIG. 7C shows an example of a message and content of the message that may be transmitted from a host vehicle to a nearby vehicle. In an embodiment, the message is similar to HL7 protocol. In an embodiment, the message comprises one or more fields from the broadcast message as depicted in FIG. 7B and additional information that is specific to the nearby vehicle under the maneuver request field. It may comprise an action that the nearby vehicle needs to take such that the host vehicle can come out of the path of the erratic vehicle. In an embodiment, it comprises an action for the nearby vehicle such that the nearby vehicle can avoid the contact of the erratic vehicle. In an embodiment, additional information can be sent which may comprise road condition and traffic condition in the vicinity of the host vehicle.

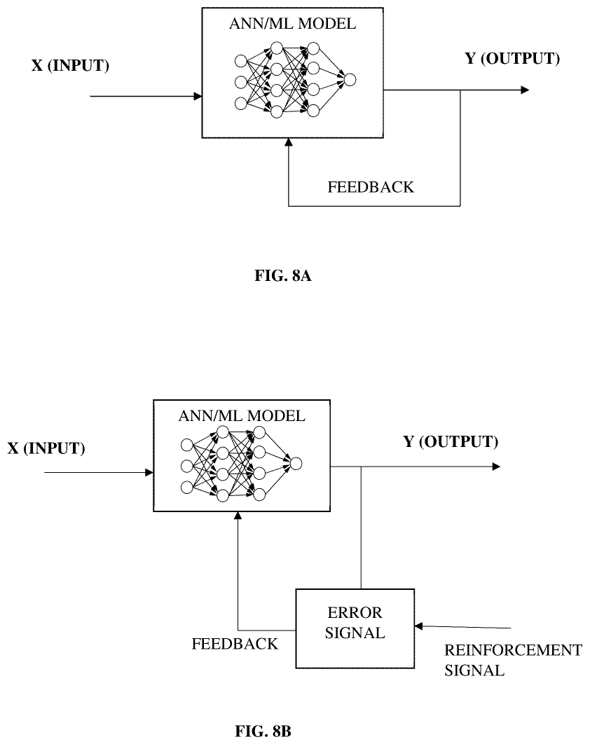

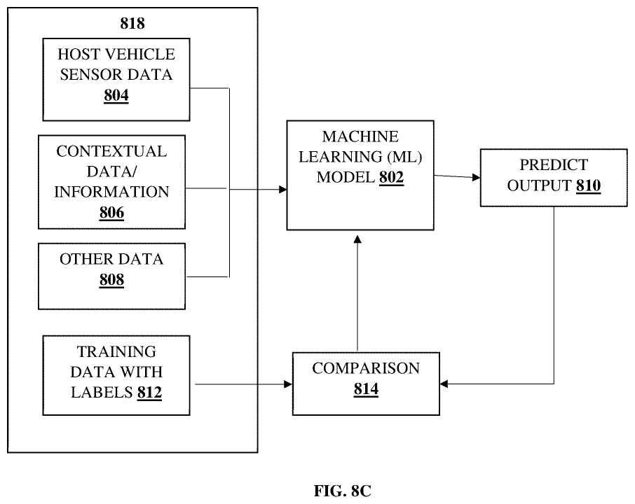

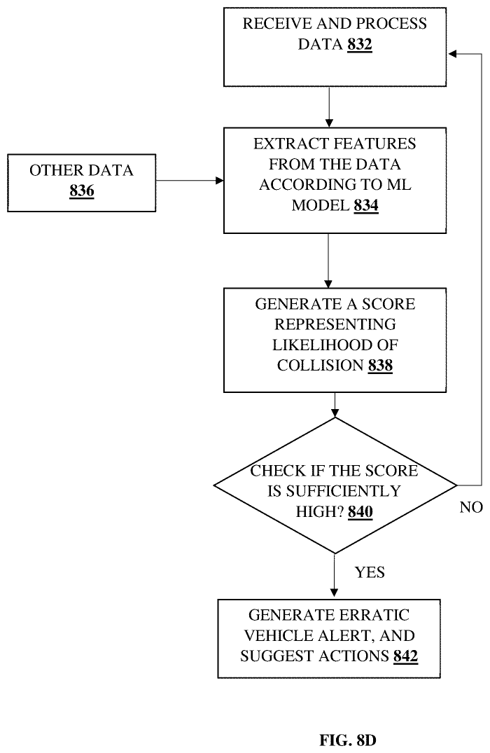

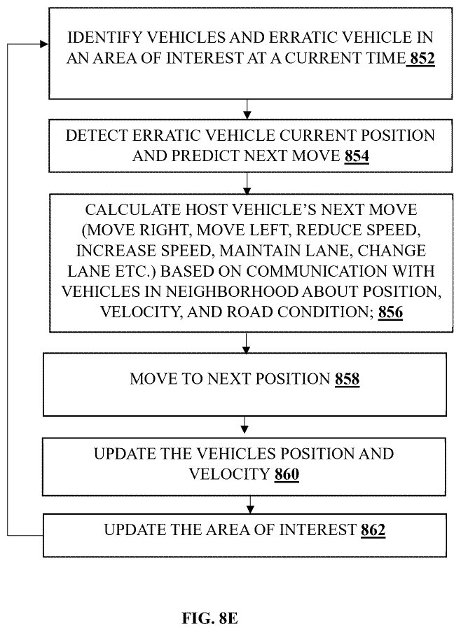

FIG. 8A shows a structure of the neural network/machine learning model with a feedback loop according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may predict an erratic vehicle, a path followed by the erratic vehicle, possibility of collision with the vehicles on the road, and collision points based on the input data.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labeled data and concepts, after a while the model's performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

AI/ML models are utilized in two contexts, i) for identifying erratic behavior, ii) for predicting erratic vehicle paths and possible collision and collision points. In an embodiment, different AI/ML models would be built and trained. In an embodiment, the model could be an integrated model performing both identifying erratic vehicles as well as predicting collision possibility and collision points.

Initially, when the AI/ML model is trained, a few labeled samples comprising both positive and negative examples of the concepts (e.g., erratic behavior patterns and normal behavior patterns etc.) are used that are meant for the model to learn. Afterward, the model is tested using unlabeled data. By using, for example, deep learning and neural networks, the model can then make predictions on whether the desired output (for e.g., whether the vehicle is an erratic vehicle or not) is in the predicted range. However, in the cases where the model returns a low probability score, this input may be sent to a controller (may be a human moderator) which verifies and, as necessary, corrects the result. The human moderator may be used only in exceptional cases. The feedback loop feeds labeled data, auto-labeled or controller-verified, back to the model dynamically and is used as training data so that the system can improve its determination in real-time and dynamically. These models may be utilized at various levels, for example, in image processing for detecting patterns of erratic vehicles given a series of images.

FIG. 8B shows a structure of the neural network/machine learning model with reinforcement learning according to an embodiment. The network receives feedback from authorized networked environments. Though the feedback system is similar to supervised learning, the feedback obtained in this case is evaluative, not instructive, which means there is no teacher as in supervised learning. After receiving the feedback, the network performs adjustments of the weights to get better predictions/identification in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

FIG. 8C shows an example block diagram for identifying an erratic behavior and erratic vehicle using a machine learning model according to an embodiment. The machine learning model 802 may take as input any data associated with the erratic vehicle, lanes, other traffic conditions, road conditions and learn to identify features within the data that are predictive of erratic behavior output. The training data sample may include, for example, the host vehicle sensor data 804 obtained from observing the surroundings for erratic behavior. Some of the data may be historical data from the host vehicle in similar situations such as similar roads, similar weather conditions, traffic intersections etc. Subsequently, the information is used to determine the erratic behavior. The systems and methods of the present disclosure may also provide data analytics information that may be used later to improve on detecting erratic vehicles, predicting a collision, and providing an evasive action.

In an embodiment, the training data sample may also include contextual data/information 806 relating to the surrounding environment. This may include, for example, location of the host vehicle, current weather conditions, temperature, time of day, traffic conditions in the region, number of lanes, other obstacles, uphill segments of the road, traffic intersections etc. The system may also garner contextual information from a device associated with the vehicle. For example, through an application installed on the device, such as an online mapping service, like Google® maps, and location services, the system may know the vehicle details. Real-time sensor data may be collected which may include, for example, video, image, audio, infrared, temperature, 3D modeling, and any other suitable types of data that capture the current state around the vehicle.

Other data 808 may include data derived from the host vehicle sensor data 804 and contextual data/information 806. For example, a possible route the host vehicle can take based on the home and office addresses accessed from user devices.

Any of the aforementioned types of data (e.g., host vehicle sensor data 804, contextual data/information 806, other data 808) may correlate with the erratic behavior identification and the correlation may be automatically learned by the machine learning model 802. In an embodiment, during training, the machine learning model 802 may process the training data sample (e.g., host vehicle sensor data 804, contextual data/information 806, other data 808), and based on the current parameters of the machine learning model 802, predict output 810 which may be identification of the erratic vehicle for the given scenario. The predicted output, which is the erratic vehicle, may depend on the training data with labels 812 associated with the training data sample 818. In an embodiment, during training, the predicted output, and the training data with labels 812 may be compared at 814. For example, comparison 814 may be based on a loss function that measures a difference between the predicted output and the training data with labels 812. Based on the comparison at 814 or the corresponding output of the loss function, a training algorithm may update the parameters of the machine learning model 802, with the objective of minimizing the differences or losses between subsequent predicted output 810 and the corresponding labels 812. By iteratively training in this manner, the machine learning model 802 may “learn” from the different training data samples and become better at predicting output 810, predicting an erratic vehicle that is similar to the ones represented by the training labels at 812.

Using the training data, a machine learning model 802 may be trained so that it recognizes features of input data that signify or correlate to erratic behavior. For example, a trained machine learning model 802 may recognize data features that signify the likelihood of a vehicle being an erratic vehicle. Through training, the machine learning model 802 may learn to identify predictive and non-predictive features and apply the appropriate weights to the features to optimize predictive accuracy of the machine learning model 802. In embodiments where supervised learning is used and each training data sample 818 has a label 812, the training algorithm may iteratively process each training data sample 818 and generate a predicted output 810 which is identification of the erratic vehicle based on patterns of erratic behavior using the machine learning model 802 current parameters. Any suitable machine learning model and training algorithm may be used, including, e.g., neural networks, decision trees, clustering algorithms, and any other suitable machine learning techniques. Once trained, the machine learning model 802 may take input data from the host vehicle and output whether a target vehicle is an erratic vehicle or not.

FIG. 8D shows an example flow chart for continuous monitoring for erratic vehicles and recommending an action using a machine learning model according to an embodiment. The system may receive real-time data associated with the host vehicle sensors and process the data as shown at 832. Any type of sensor may be used to gather data of the surroundings from the host vehicle. A sensor output may be, for example, images, videos, audios, LiDAR measures, infrared measures, temperature measures, GPS data, traffic signal data, or any other information measured or detected by sensors. In an embodiment, a sensor output may be the result of one or more sensors capturing environmental information associated with the surroundings of the vehicle, which may include traffic condition at the location, target vehicle details, number of lanes, traffic condition around the host vehicle, road surface condition, etc. The system may receive any data associated with the sensor output from sensors, including raw sensory output and/or any derivative data. In an embodiment, the system may process the received data and identify any actionable parameter of interest using a machine learning model, trained using a set of training data. It may receive other data 836, such as weather conditions, humidity, temperature, driver behavior, tire tread, tire conditions, tire pressure, etc., from other sensors of the host vehicle.

As shown at step 834, the system may extract features from the received data using a machine learning model. The machine learning model is able to automatically do so based on what it learned during the training process. In an embodiment, appropriate weights that were learned during the training process may be applied to the features. The features include erratic behavior pattern, path followed by the erratic vehicle for the past few time segments, speed of the erratic vehicle, acceleration of the erratic vehicle, steering position, type of erratic vehicle, etc.

As shown at step 838, the machine learning model, based on the features of the received data, may detect erratic vehicle, then predict a segment of the path to be followed by erratic vehicle, and subsequently generate possible collision points on the segment of the path that may be followed by the erratic vehicle. The machine learning model would generate a first score representing a likelihood of collision and a second score based on the predicted severity or impact of the collision. The two scores may be combined with weights to generate a score.

As shown at step 840, the system may determine whether the score is sufficiently high relative to a threshold or criteria to warrant certain action. If the score is not sufficiently high, thus indicating a false-positive, the system may return to step 832 and continue to monitor subsequent incoming data. On the other hand, if the score is sufficiently high, then at step 842 the system may generate an alert to the host vehicle and generate or determine an appropriate action/response for the host vehicle. In an embodiment, the system may send alerts to nearby vehicles or a group of nearby vehicles. For instance, an alert is generated in the nearby vehicle via a message wherein the message comprises one or more of details of the erratic vehicle, and request for an action or a coordinated action, wherein the action comprises one or more of reducing a speed, increasing a speed, moving forward in the lane, moving backward in the lane, and a change of lane.

In an embodiment, the system may repeat one or more steps of the method of FIG. 8D, where appropriate. In an embodiment, the steps 832 to 842 may be performed by the system, any combination of those steps may be performed by any other computing systems, for example, a remote network or a cloud network. In an embodiment, where machine learning models are used for making such determination, the system may transmit a trained machine learning model to the computing system in the vehicle. This may be desirable since sensor data may be overly large to transmit to the in vehicle system for training in a timely fashion.

In an embodiment, the detecting of an erratic vehicle and predicting a path of erratic vehicle and collision points utilizes a Convolutional Neural Networks (CNN). In an embodiment, it may use a recurrent neural network architecture because of its ability to use past, temporal information for inference on current inputs.

FIG. 8E shows an example flow chart for coordinated moving of vehicles using swarm intelligence to avoid a collision/contact zone with the erratic vehicle. In an embodiment, swarm intelligence is used for coordinated moves. Host vehicle would identify vehicles and erratic vehicles in an area of interest at a current time at step 852. The host vehicle would detect erratic vehicle current position and predict next move of the erratic vehicle at step 854. The host vehicle calculates its next move, next move could be moving right, moving left, reducing speed, increasing speed, maintaining lane, changing lane, complete stop etc., based on communication with vehicles in the neighborhood, communicating about their position, velocity, and road condition at step 856. During this step 856 the host vehicle will simultaneously check and avoid collision with neighboring vehicles and check and avoid erratic vehicle paths or zones. The host then will move to its next position at step 858, the host vehicle then updates the position and velocity of the surrounding vehicles at step 860. As the erratic vehicle and the traffic condition is dynamic, the host vehicle will update the area of interest at step 862 and repeat the process until it steers clear of the erratic vehicle and its path/contact zone. The area of interest according to an embodiment, could be an area where the vehicles are in the vicinity of the erratic vehicle or contact zone and the erratic vehicle poses a threat to the vehicles in that area. In an embodiment, the host vehicle and the vehicles in the area of interest form into a swarm and coordinate their actions using swarm intelligence. The emergent behavior arises from the interactions of individual vehicles within the swarm. Each vehicle follows simple rules (move forward, change lanes, avoid collisions) based on its local environment, leading to complex collective behavior at the swarm level. Swarm intelligence algorithms, inspired by the collaborative behaviors of social organisms, offer innovative solutions to complex problems. Examples include Ant Colony Optimization (ACO), where ants deposit pheromones to guide the colony toward optimal solutions, and Particle Swarm Optimization (PSO), where agents adjust positions based on collective experiences. The Bee Algorithm mimics honey bees' foraging through exploration and communication, while the Firefly Algorithm draws inspiration from synchronized firefly flashing for optimal solution convergence. Swarm Robotics employs local communication for tasks like exploration, and Stigmergy involves indirect communication through environmental modifications. Any of the algorithms mentioned herein are suitable and adaptable for the maneuvers and avoidance of contact zone of the erratic vehicle.

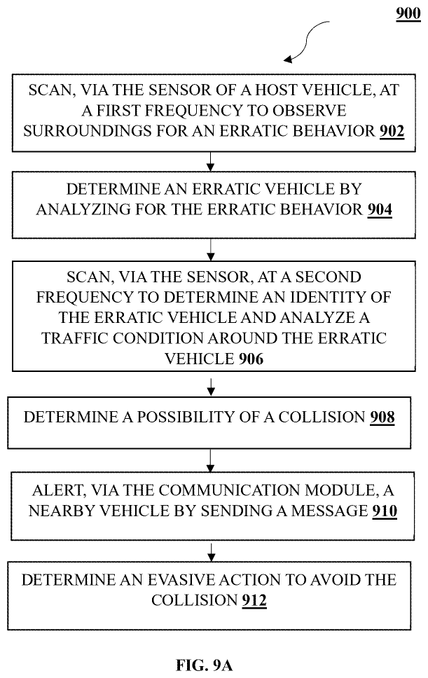

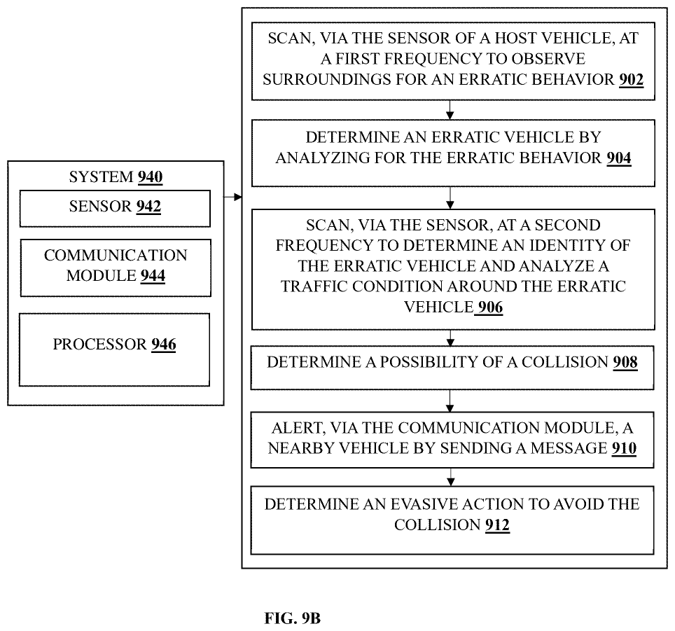

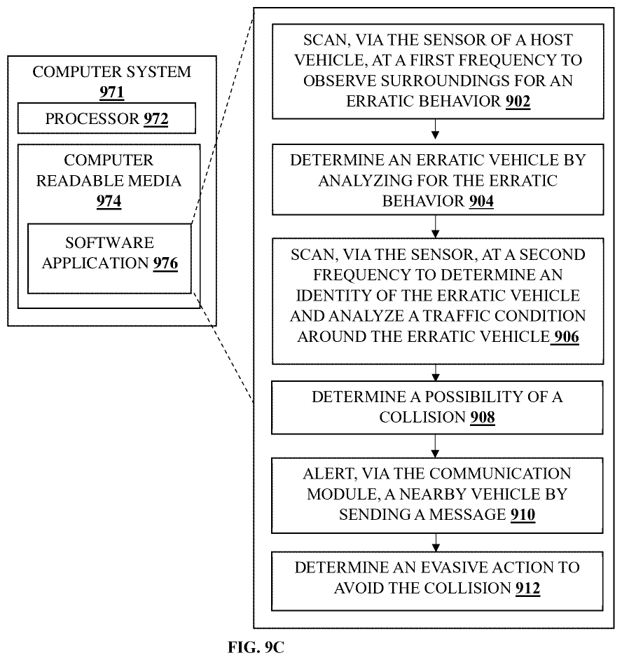

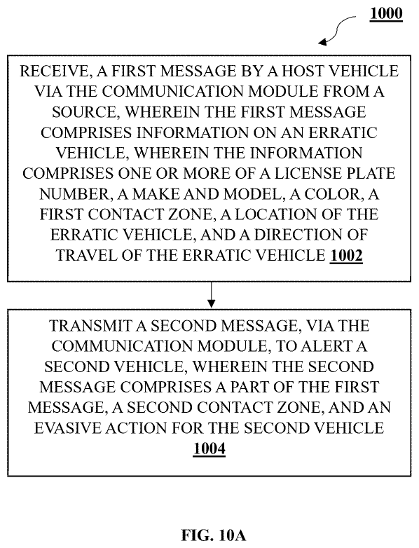

FIG. 9A shows a block diagram for a method for detecting an erratic vehicle and determining an evasive action according to an embodiment. According to an embodiment, it is a method 900 comprising, scanning, via a sensor of a host vehicle, at a first frequency to observe surroundings for an erratic behavior as shown at step 902; determining an erratic vehicle by analyzing for the erratic behavior as shown at step 904; scanning, via the sensor, at a second frequency to determine an identity of the erratic vehicle and analyze a traffic condition around the erratic vehicle as shown at step 906; determining a possibility of a collision as shown at step 908; alerting, via a communication module, a nearby vehicle by sending a message as shown at step 910; and determining an evasive action to avoid the collision as shown at step 912.

FIG. 9B shows a block diagram for a system for detecting an erratic vehicle and determining an evasive action according to an embodiment. According to an embodiment, it is a system 940 comprising, a sensor 942, a communication module 944; and a processor 946; wherein the processor 946 storing instructions in a non-transitory memory that, when executed, cause the processor to scan, via the sensor of a host vehicle, at a first frequency to observe surroundings for an erratic behavior as shown at step 902; determine an erratic vehicle by analyzing for the erratic behavior as shown at step 904; scan, via the sensor, at a second frequency to determine an identity of the erratic vehicle and analyze a traffic condition around the erratic vehicle as shown at step 906; determine a possibility of a collision as shown at step 908; alert, via the communication module, a nearby vehicle by sending a message as shown at step 910; and determine an evasive action to avoid the collision as shown at step 912. According to an embodiment of the system, the system is a component of a vehicle. According to an embodiment of the system, the traffic condition comprises a number of vehicles and their speed.

According to an embodiment of the system, the second frequency is higher than the first frequency. According to an embodiment of the system, the first frequency is adjusted dynamically to the second frequency based on one or more of a traffic condition, a weather condition, a geo location, a road condition, and a distance from the erratic vehicle.

According to an embodiment of the system, the erratic behavior comprises one or more of a swerving, a speeding, a sudden lane change, a frequency of lane change, an acceleration above a first threshold, and a deceleration below a threshold, a vehicle with emergency lights on, a vehicle with siren on, and vehicle at a complete stop.

According to an embodiment of the system, the system further comprises a machine vision system and an artificial intelligence module operable to determine the erratic behavior, and wherein the system is operable to identify a pattern indicative of the erratic behavior in the surroundings using an artificial intelligence module. According to an embodiment of the system, the machine vision system and the artificial intelligence module is operable to determine a collision avoidance action.

According to an embodiment of the system, the communication module is operable for vehicle-to-everything (V2X) communication and vehicle-to-vehicle (V2V) communication.

According to an embodiment of the system, the sensor comprises one or more of a camera, a radar sensor, a lidar sensor, and an ultrasonic sensor.

According to an embodiment of the system, the host vehicle performs the evasive action. According to an embodiment of the system, a request for evasive action considers energy requirements, a weather condition, a traffic condition, and a time requirement for a destination. According to an embodiment of the system, the evasive action comprises one or more of maintaining a distance of the host vehicle from the erratic vehicle, adjusting a distance of the host vehicle from the erratic vehicle, performing a change in a route, performing a reverse maneuver, and performing a lane change.

FIG. 9C shows a block diagram for a method stored on a non-transitory computer medium for detecting an erratic vehicle and determining an evasive action according to an embodiment. According to an embodiment, it is a non-transitory computer readable storage medium 974 having stored thereon instructions executable by a computer system 971 to perform operations comprising, scanning, via a sensor of a host vehicle, at a first frequency to observe surroundings for an erratic behavior as shown at step 902; determining an erratic vehicle by analyzing for the erratic behavior as shown at step 904; scanning, via the sensor, at a second frequency to determine an identity of the erratic vehicle and analyze a traffic condition around the erratic vehicle as shown at step 906; determining a possibility of a collision as shown at step 908; alerting, via a communication module, a nearby vehicle by sending a message as shown at step 910; and determining an evasive action to avoid the collision as shown at step 912. A software application 976 may be stored on the computer readable storage medium 974 and executed with processor 972 of the computer system 971.

According to an embodiment of the non-transitory computer readable storage medium, the instructions further comprise identifying a pattern indicative of the erratic behavior in the surroundings using an artificial intelligence module.

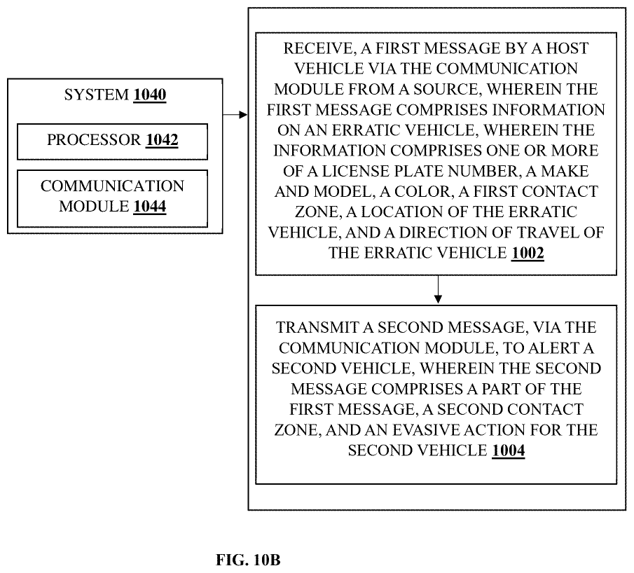

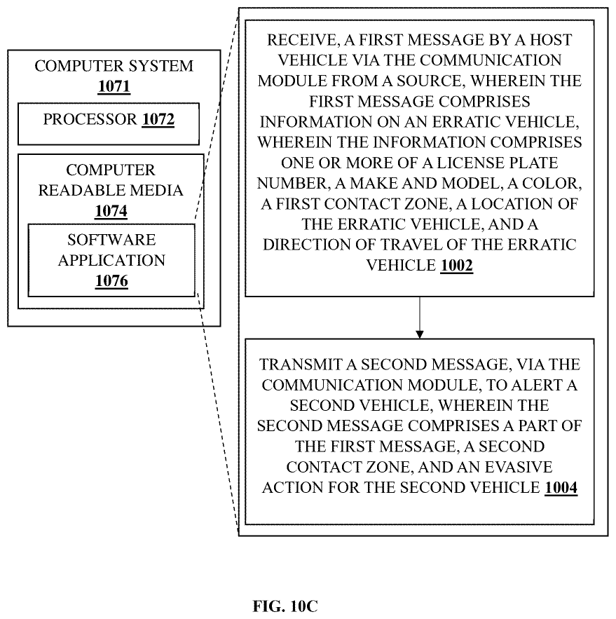

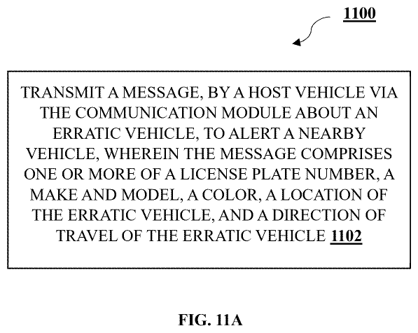

FIG. 10A shows a block diagram for a method for receiving and transmitting a message by the host vehicle according to an embodiment. According to an embodiment, it is a method 1000 comprising, receiving, a first message by a host vehicle via a communication module from a source, wherein the first message comprises information on an erratic vehicle, wherein the information comprises one or more of a license plate number, a make and model, a color, a first contact zone, a location of the erratic vehicle, and a direction of travel of the erratic vehicle at step 1002; and transmitting a second message, via the communication module, to alert a second vehicle, wherein the second message comprises a part of the first message and an evasive action for the second vehicle at step 1004, and wherein the source is one of a first vehicle, a device, and a traffic infrastructure.

According to an embodiment of the method, the evasive action for the second vehicle comprises one or more of a change in route, a change in lane, a change in speed, a change in direction of travel, a change in distance from the host vehicle.

FIG. 10B shows a block diagram for a system for receiving and transmitting a message by the host vehicle according to an embodiment. According to an embodiment, it is a system 1040 comprising, a communication module 1044; and a processor 1042; wherein the processor 1042 storing instructions in a non-transitory memory that, when executed, causes the processor to receive, a first message by a host vehicle via the communication module from a source, wherein the first message comprises information on an erratic vehicle, wherein the information comprises one or more of a license plate number, a make and model, a color, a first contact zone, a location of the erratic vehicle, and a direction of travel of the erratic vehicle at step 1002; and transmit a second message, via the communication module, to alert a second vehicle, wherein the second message comprises a part of the first message, a second contact zone, and an evasive action for the second vehicle; and wherein the system is a component of the host vehicle at step 1004, and wherein the source is one of a first vehicle, a device, and a traffic infrastructure.

According to an embodiment of the system, the system is operable for broadcasting the second message. According to an embodiment of the system, the first message further comprises a noticeable feature of the erratic vehicle, wherein the noticeable feature comprises one or more of a bumper sticker, a dent, and any special accessory attached to the erratic vehicle.

According to an embodiment of the system, the first message further comprises a request for the host vehicle to move in a specific direction. According to an embodiment of the system, the system is further operable to display an action to a driver of the host vehicle.

According to an embodiment of the system, the second contact zone is different from the first contact zone, and wherein the second contact zone is an updated area from that of the first contact zone comprising a different group of vehicles.

FIG. 10C shows a block diagram for a method stored on a non-transitory computer medium for receiving and transmitting a message by the host vehicle according to an embodiment.

According to an embodiment, it is a non-transitory computer readable storage medium 1074 having stored thereon instructions executable by a computer system 1071 to perform operations comprising, receiving, a first message by a host vehicle via a communication module from a source, wherein the first message comprises information on an erratic vehicle, wherein the information comprises one or more of a license plate number, a make and model, a color, a first contact zone, a location of the erratic vehicle, and a direction of travel of the erratic vehicle at step 1002; and transmitting a second message, via the communication module, to alert a second vehicle, wherein the second message comprises a part of the first message and an evasive action for the second vehicle at step 1004. A software application 1076 may be stored on the computer readable storage medium 1074 and executed with processor 1072 of the computer system 1071; and wherein the source is one of a first vehicle, a device, and a traffic infrastructure.

According to an embodiment of the non-transitory computer readable storage medium, the evasive action for the second vehicle comprises one or more of a change in route, a change in lane, a change in speed, a change in direction of travel, a change in distance from the host vehicle. According to an embodiment of the non-transitory computer readable storage medium, the second message is transmitted to a road infrastructure via the communication module comprising V2X communication.

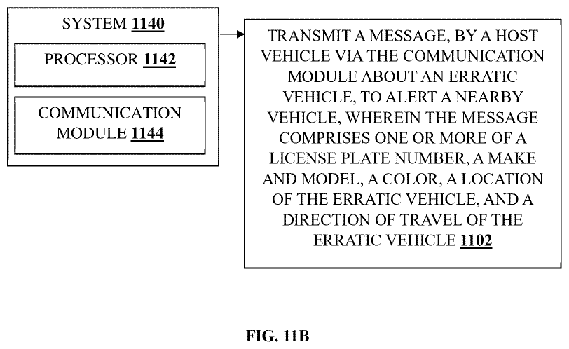

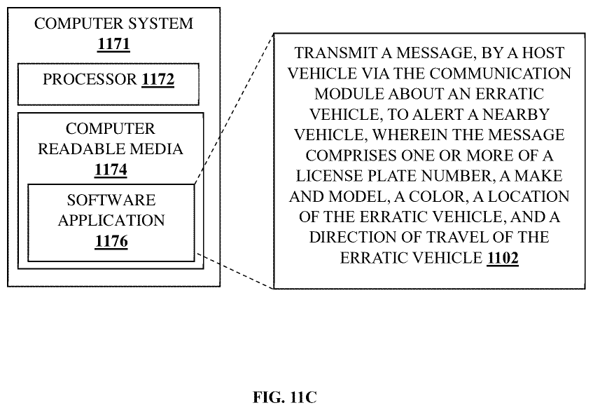

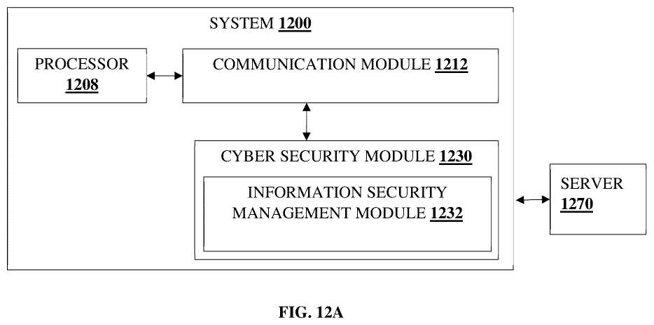

FIG. 11A shows a block diagram for a method for transmitting a message by the host vehicle according to an embodiment.

According to an embodiment, it is a method 1100 comprising, transmitting a message, by a host vehicle via a communication module about an erratic vehicle, to alert a nearby vehicle, wherein the message comprises one or more of a license plate number, a make and model, a color, a location of the erratic vehicle, and a direction of travel of the erratic vehicle at step 1102.

According to an embodiment of the method, the message further comprises an evasive action for the nearby vehicle. According to an embodiment of the method, the evasive action for the nearby vehicle comprises one or more of a change in route, a change in lane, a change in speed, a change in direction of travel, a change in distance from the host vehicle.

FIG. 11B shows a block diagram for a system for transmitting a message by the host vehicle according to an embodiment.

According to an embodiment, it is a system 1140 comprising, a communication module 1144; and a processor 1142; wherein the processor storing instructions in a non-transitory memory that, when executed, cause the processor to: transmit a message, by a host vehicle via the communication module about an erratic vehicle, to alert a nearby vehicle, wherein the message comprises one or more of a license plate number, a make and model, a color, a location of the erratic vehicle, and a direction of travel of the erratic vehicle at step 1102.

According to an embodiment of the system, the message further comprises a request for the nearby vehicle to move in a direction, wherein the direction comprises a change in lane, a change in route, and a change in distance from the host vehicle. According to an embodiment of the system, the system is further operable to display an action to a driver of the host vehicle. According to an embodiment of the system, the system is further operable to display the message to a driver of the nearby vehicle.

FIG. 11C shows a block diagram for a method stored on a non-transitory computer medium for transmitting a message by the host vehicle according to an embodiment.

According to an embodiment, it is a non-transitory computer readable storage medium having stored thereon instructions executable by a computer system to perform operations comprising, transmitting a message, by a host vehicle via a communication module about an erratic vehicle, to alert a nearby vehicle, wherein the message comprises one or more of a license plate number, a make and model, a color, a location of the erratic vehicle, and a direction of travel of the erratic vehicle as shown at step 1102. A software application 1176 may be stored on the computer readable storage medium 1174 and executed with processor 1172 of the computer system 1171. According to an embodiment of the non-transitory computer readable storage medium, the message further comprises an evasive action for the nearby vehicle.

According to an embodiment of the non-transitory computer readable storage medium, the evasive action for the nearby vehicle comprises one or more of a change in route, a change in lane, a change in speed, a change in direction of travel, a change in distance from the host vehicle. According to an embodiment of the non-transitory computer readable storage medium, the message is transmitted to a road infrastructure via V2X communication.

In an embodiment, the system may comprise a cyber security module. In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle state and transmit the converted first data message into a first data format associated with the vehicle environment and transmit the converted first data message to the communication module using a first communication protocol associated with the negotiated protocol.

According to an embodiment, secure authentication for data transmissions comprises, provisioning a hardware-based security engine (HSE) located in the cyber security module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the cyber security module with other computing system subjects (e.g., communication module) to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

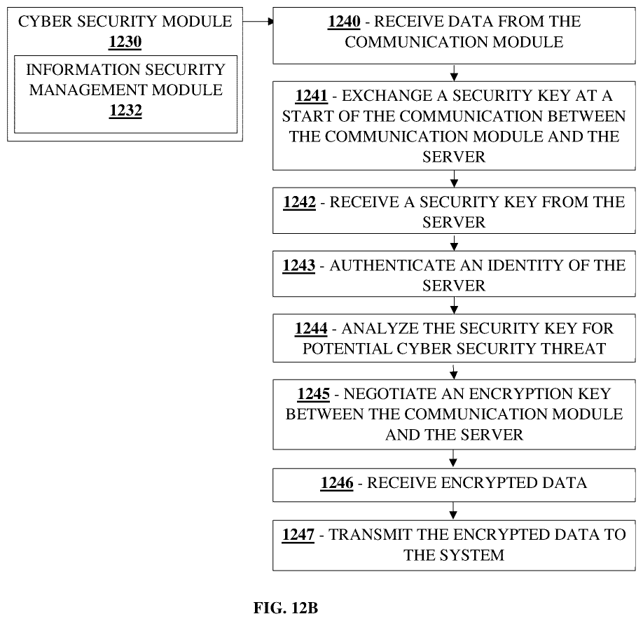

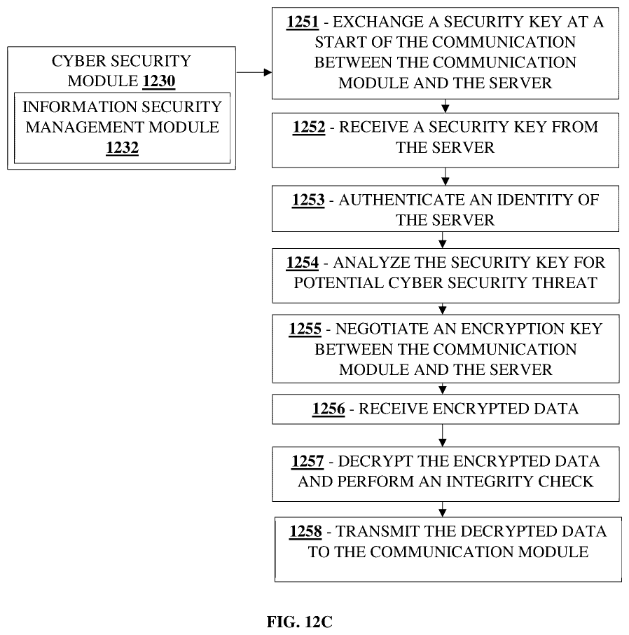

FIG. 12A shows the block diagram of the cyber security module according to an embodiment. In an embodiment, FIG. 12A shows the block diagram of the cyber security module. The communication of data between the system 1200 and the server 1270 through the communication module 1212 is first verified by the information security management module 1232 before being transmitted from the system to the server or from the server to the system. The information security management module is operable to analyze the data for potential cyber security threats, to encrypt the data when no cyber security threat is detected, and to transmit the data encrypted to the system or the server. The system 1200 comprises processor 1208.

In an embodiment, the cyber security module further comprises an information security management module providing isolation between the system and the server. FIG. 12B shows the flowchart of securing the data through the cyber security module 1230. At step 1240, the information security management module is operable to receive data from the communication module. At step 1241, the information security management module exchanges a security key at the start of the communication between the communication module and the server. At step 1242, the information security management module receives a security key from the server. At step 1243, the information security management module authenticates an identity of the server by verifying the security key. At step 1244, the information security management module analyzes the security key for potential cyber security threats. At step 1245, the information security management module negotiates an encryption key between the communication module and the server. At step 1246, the information security management module receives the encrypted data. At step 1247, the information security management module transmits the encrypted data to the server when no cyber security threat is detected.

In an embodiment, FIG. 12C shows the flowchart of securing the data through the cyber security module 1230. At step 1251, the information security management module is operable to: exchange a security key at the start of the communication between the communication module and the server. At step 1252, the information security management module receives a security key from the server. At step 1253, the information security management module authenticates an identity of the server by verifying the security key. At step 1254, the information security management module analyzes the security key for potential cyber security threats. At step 1255, the information security management module negotiates an encryption key between the communication module and the server. At step 1256, the information security management module receives encrypted data. At step 1257, the information security management module decrypts the encrypted data, and performs an integrity check of the decrypted data. At step 1258, the information security management module transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 12A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carried out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key is bound to the session ID number; when the system sends data to the outside, the information security gateway receives the data through the communication module, performs integrity authentication on the data, then encrypts the data through a negotiated secret key, and finally transmits the data to the server through the communication module. When the information security management module receives data from the server, the data is decrypted first, integrity verification is carried out on the data after decryption, and if verification is passed, the data is sent out through the communication module; otherwise, the data is discarded. In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-37. (canceled)

38. A system comprising,
a communication module; and a processor;
wherein the processor storing instructions in a non-transitory memory that, when executed, cause the processor to:
receive, a first message by a host vehicle via the communication module from a source, wherein the first message comprises information on an erratic vehicle, wherein the information comprises one or more of a license plate number, a make and model, a color, a first contact zone, a location of the erratic vehicle, and a direction of travel of the erratic vehicle; and
transmit a second message, via the communication module, to alert a second vehicle, wherein the second message comprises a part of the first message, a second contact zone, and an evasive action for the second vehicle; and
wherein the system is a component of the host vehicle; and wherein the source is one of a first vehicle, a device, and a traffic infrastructure.

39. The system of claim 38, wherein the system is operable for broadcasting the second message.

40. The system of claim 38, wherein the first message further comprises a noticeable feature of the erratic vehicle, wherein the noticeable feature comprises one or more of a bumper sticker, a dent, and any special accessory attached to the erratic vehicle.

41. The system of claim 38, wherein the first message further comprises an image of the erratic vehicle.

42. The system of claim 38, wherein the first message further comprises an image of a driver of the erratic vehicle and of passengers of the erratic vehicle.

43. The system of claim 38, wherein the first message further comprises one or more of an image of the first contact zone created by the erratic vehicle.

44. The system of claim 38, wherein the first contact zone comprises an areas where a group of surrounding vehicles that are moving at a speed at least one of above a first threshold speed, below a second threshold speed, and one or more vehicles are involved in a vehicle pursuit.

45. The system of claim 44, wherein the first threshold speed and the second threshold speed are determined based on a speed limit on a route on which the erratic vehicle is travelling and an average speed of vehicles which are away from the erratic vehicle.

46. The system of claim 38, wherein the first message further comprises a request for the host vehicle to move in a specific direction.

47. The system of claim 46, wherein the specific direction comprises a change in lane, a change in route, and a change in distance from the host vehicle.

48. The system of claim 46, wherein the specific direction is displayed as a vector.

49. The system of claim 38, wherein the second contact zone is different from the first contact zone, and wherein the second contact zone is an updated situation about the first contact zone.

50. The system of claim 38, wherein the second message further comprises a request for a daisy chain communication to notify other surrounding vehicles within a geographical range or a route of a nearby vehicle.

51. The system of claim 38, wherein the system is further operable to display the first message to a driver of the host vehicle.

52. The system of claim 38, wherein the system is further operable to display the second message to a driver of the second vehicle.

53. A method comprising,
receiving, a first message by a host vehicle via a communication module from a source, wherein the first message comprises information on an erratic vehicle, wherein the information comprises one or more of a license plate number, a make and model, a color, a first contact zone, a location of the erratic vehicle, and a direction of travel of the erratic vehicle; and
transmitting a second message, via the communication module, to alert a second vehicle, wherein the second message comprises a part of the first message and an evasive action for the second vehicle; and wherein the source is one of a first vehicle, a device, and a traffic infrastructure.

54. The method of claim 53, wherein the evasive action for the second vehicle comprises one or more of a change in route, a change in lane, a change in speed, a change in direction of travel, a change in distance from the host vehicle.

55. A non-transitory computer readable storage medium having stored thereon instructions executable by a computer system to perform operations comprising,
receiving, a first message by a host vehicle via a communication module from a source, wherein the first message comprises information on an erratic vehicle, wherein the information comprises one or more of a license plate number, a make and model, a color, a first contact zone, a location of the erratic vehicle, and a direction of travel of the erratic vehicle; and
transmitting a second message, via the communication module, to alert a second vehicle, wherein the second message comprises a part of the first message and an evasive action for the second vehicle; and wherein the source is one of a first vehicle, a device, and a traffic infrastructure.

56. The non-transitory computer readable storage medium of claim 55, wherein the evasive action for the second vehicle comprises one or more of a change in route, a change in lane, a change in speed, a change in direction of travel, a change in distance from the host vehicle.

57. The non-transitory computer readable storage medium of claim 55, wherein the second message is transmitted to a road infrastructure via the communication module comprising V2X communication.
